(19) United States
(12) Patent Application Publication
(10) Pub. No.: US 2022/0217438 A1
(43) Pub. Date: Jul. 7, 2022

(54) DISPLAY CONTROL DEVICE, DISPLAY CONTROL METHOD, AND PROGRAM

(71) Applicant: SONY CORPORATION, Tokyo (JP)

(72) Inventors: Masako KOMURO, Tokyo (JP); Hirofumi SHIMADA, Kanagawa (JP); Kouji OGAWA, Tokyo (JP)

(73) Assignee: SONY CORPORATION, Tokyo (JP)

(21) Appl. No.: 17/267,998

(22) PCT Filed: Aug. 30, 2019
(86) PCT No.: PCT/JP2019/034058

§ 371 Date: Feb. 11, 2021

(30) Foreign Application Priority Data
Sep. 14, 2018 (JP) 2018-172631

(51) Int. Cl. H04N 21/431; H04N 21/4722; H04N 21/4728; H04N 21/84

(52) U.S. Cl. CPC H04N 21/4312; H04N 21/84; H04N 21/4728; H04N 21/4722

(57) ABSTRACT

The present disclosure relates to a display control device, a display control method, and a program that enable improvement of the user experience of a user who views and listens to content.

A superimposition-data generation unit generates, in reproduction of content hierarchically including a plurality of high-definition partial pictures and a low-resolution entire picture including the plurality of partial pictures as regions, superimposition data to be superimposed onto the entire picture, on the basis of metadata regarding the partial pictures. A display-picture generation unit generates a display picture in which a picture based on the superimposition data is superimposed on the entire picture. Then, a request transmission unit transmits a request for distribution of a desired partial picture selected with the display picture. The present technology can be applied to, for example, distribution of content hierarchically including a plurality of high-definition partial pictures and a low-resolution entire picture including the plurality of partial pictures as regions.

### TECHNICAL FIELD

The present disclosure relates to a display control device, a display control method, and a program. The present disclosure particularly relates to a display control device, a display control method, and a program

that enable improvement of the user experience of a user who views and listens to content hierarchically including a plurality of partial pictures and an entire picture including the plurality of partial pictures as regions.

### BACKGROUND ART

Conventionally, content is distributed such that an entire picture, such as an entire-celestial-spherical or omnidirectional picture or a panoramic picture, is reproduced and the display region of the entire picture is moved or switched in response to an operation from a user, resulting in display of a high-definition partial picture hierarchically arranged at part of the entire picture.

For example, as disclosed in Non-Patent Document 1, format for preparing a low-resolution entire-celestial-spherical and all-directional picture and high-definition pictures hierarchically divided in the picture, has been prescribed.

### CITATION LIST

### Non-Patent Document

Non-Patent Document 1: Information technology—Coded representation of immersive media (MPEG-I)—Part 2: Omnidirectional media format

### SUMMARY OF THE INVENTION

### Problems to be Solved by the Invention

By the way, in reproduction of such content as described above, a user performs operations to the content while viewing and listening to a low-resolution entire picture such that an area that the user desires to view and listen to in more detail is zoomed and a high-resolution partial picture in the area is selected, resulting in a request for distribution thereof. However, in some cases, no high-resolution partial pictures are present in practice in the area zoomed by the user having been viewing and listening to the low-resolution entire picture, and thus the operation to the content results in waste. Therefore, improvement of user experience is required with acquisition of favorable operability to such content.

The present disclosure has been made in consideration of such a situation, and an object of the present disclosure is to enable improvement of the user experience of a user who views and listens to content hierarchically including a plurality of partial pictures and an entire picture including the plurality of partial pictures as regions.

### Solutions to Problems

According to one aspect of the present disclosure, provided is a display control device including: a superimposition-data generation unit configured to generate, in reproduction of content hierarchically including a plurality of high-definition partial pictures and a low-resolution entire picture including the plurality of partial pictures as regions, superimposition data to be superimposed onto the entire picture, on the basis of metadata regarding the partial pictures; a display-picture generation unit configured to generate a display picture in which a picture based on the superimposition data is superimposed on the entire picture; and a request transmission unit configured to transmit a request for distribution of a desired partial picture selected from the partial pictures with the display picture.

According to one aspect of the present disclosure, provided is a display control method or a program including: generating, in reproduction of content hierarchically including a plurality of high-definition partial pictures and a low-resolution entire picture including the plurality of partial pictures as regions, superimposition data to be superimposed onto the entire picture, on the basis of metadata regarding the partial pictures; generating a display picture in which a picture based on the superimposition data is superimposed on the entire picture; and transmitting a request for distribution of a desired partial picture selected from the partial pictures with the display picture.

According to one aspect of the present disclosure, in reproduction of content hierarchically including a plurality of high-definition partial pictures and a low-resolution entire picture including the plurality of partial pictures as regions, superimposition data to be superimposed onto the entire picture is generated, on the basis of metadata regarding the partial pictures. Generated is a display picture in which a picture based on the superimposition data is superimposed on the entire picture. Transmitted is a request for distribution of a desired partial picture selected with the display picture.

### BRIEF DESCRIPTION OF DRAWINGS

FIG. 1 is a block diagram of an exemplary configuration of a content distribution system according to a first embodiment to which the present technology is applied.

FIG. 2 is an explanatory view of display modes of low-resolution entire pictures.

FIG. 3 is an explanatory view of a user interface on which high-resolution areas are superimposed on a low-resolution entire picture.

FIG. 4 is an explanatory view of user interfaces according to modifications.

FIG. 5 is as explanatory view of user interfaces according to modifications.

FIG. 6 is an explanatory view of user interfaces according to modifications.

FIG. 7 is a block diagram of an exemplary configuration of a mobile display device.

FIG. 8 is an explanatory flowchart of first content distribution processing.

FIG. 9 is as explanatory flowchart of second content distribution processing.

FIG. 10 is an explanatory flowchart of third content distribution processing.

FIG. 11 is an explanatory flowchart of fourth content distribution processing.

FIG. 12 is an explanatory flowchart of fifth content distribution processing.

FIG. 13 is an explanatory flowchart of processing of requesting generation of a high-resolution partial picture.

FIG. 14 is an explanatory flowchart of sixth content distribution processing.

FIG. 15 is a block diagram of an exemplary configuration of a content distribution system according to a second embodiment to which the present technology is applied.

FIG. 16 is an explanatory view of a first exemplary operation to content with a remote controller.

FIG. 17 is ac explanatory view of a second exemplary operation to content with the remote controller.

FIG. 18 is an explanatory view of a third exemplary operation to content with the remote controller.

FIG. 19 is an explanatory view of exemplary allocation of functions to existing buttons of the remote controller.

FIG. 20 is an explanatory view of operation units for spatial control.

FIG. 21 is a block diagram of an exemplary configuration of a large-screen display device.

FIG. 22 is an explanatory flowchart of seventh content distribution processing.

FIG. 23 is a block diagram of an exemplary configuration of a computer according to an embodiment to which the present technology is applied.

### MODE FOR CARRYING OUT THE INVENTION

Specific embodiments to which the present technology is applied, will be described in detail below with reference to the drawings.

### First Exemplary Configuration of Content Distribution System

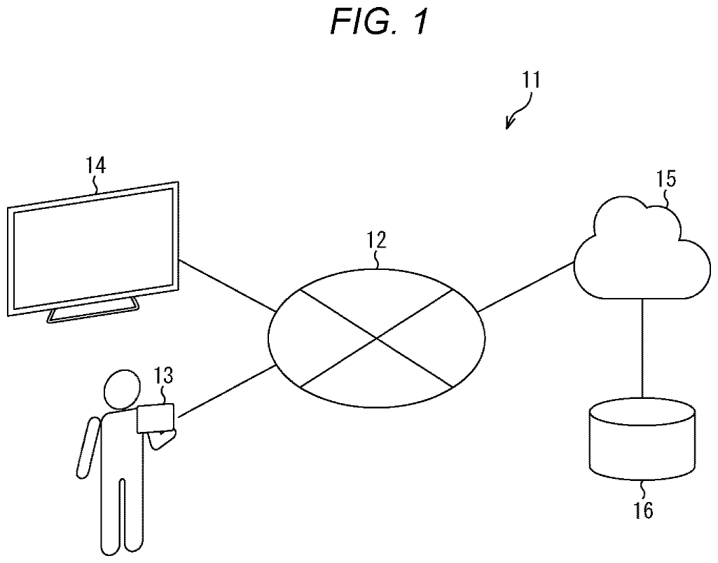

FIG. 1 is a block diagram of an exemplary configuration of a content distribution system according to a first embodiment to which the present technology is applied.

The content distribution system 11 illustrated in FIG. 1 includes a mobile display device 13, a large-screen display device 14, and a distribution server 15 connected through a network 12. The distribution server 15 is connected with a content storage unit 16.

The mobile display device 13 is, for example, a portable and compact display device including a touch panel display capable of displaying a picture and additionally accepting a touch operation from a user. Furthermore, the mobile display device 13 is capable of performing direct wireless communication with the large-screen display device 14 and additionally performing communication with the distribution server 15 through the network 12. Note that, as the mobile display device 13, in addition to use of a so-called tablet-type information processing device, various types of display devices capable of displaying a picture in response to an operation from a user can be used, such as a personal computer, a stationary large-screen television receiver, a projector, and the like.

The large-screen display device 14 is, for example, a large-size display device capable of displaying a high-definition picture. The large-screen display device 14 is capable of performing direct wireless communication with the mobile display device 13 and additionally performing communication with the distribution server 15 through the network 12. As the large-screen display device 14, for example, a stationary large-screen television receiver, a projector, or the like can be used.

The distribution server 15 includes a plurality of server groups connected to the network 12 and provides, on the network 12, a service of distributing content read from the content storage unit 16.

The content storage unit 16 stores content to be distributed in the content distribution system 11. Content stored in the content storage unit 16 includes, for example, a low-resolution entire picture and hierarchically divided high-resolution partial pictures and has a manifest describing various types of information necessary for control of distribution thereof.

In the content distribution system 11 having such a configuration, a user operates the mobile display device 13 and selects a high-resolution partial picture from a low-resolution entire picture displayed on the mobile display device 13, so that the high-resolution partial picture can be displayed on the mobile display device 13 or the large-screen display device 14.

For example, in a case where distribution control of content and display of a high-resolution partial picture are performed by the same equipment, the high-resolution partial picture is displayed on the mobile display device 13. In this case, the content distribution system 11 may exclude the large-screen display device 14. Meanwhile, in a case where distribution control of content and display of a high-resolution partial picture are performed by different pieces of equipment, the high-resolution partial picture is displayed on the large-screen display device 14.

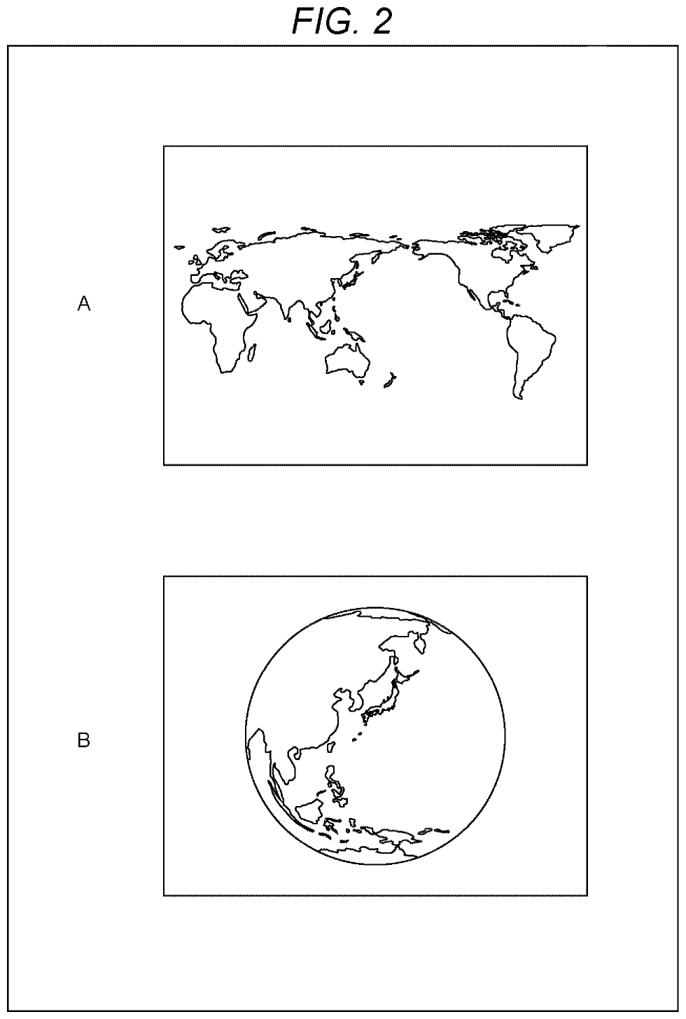

The display mode of a low-resolution entire picture that is distributed in the content distribution system 11, will be described with reference to FIG. 2.

In the content distribution system. 11, a low-resolution entire picture is distributed in a display mode pursuant to, for example, such equirectangular (ER) projection as illustrated in A of FIG. 2 or such azimuthal equidistant projection as illustrated in B of

FIG. 2.

For example, in a case where a low-resolution entire picture in the display mode pursuant to the equirectangular projection has been displayed on the mobile display device 13, the user can perform operations to the touch panel display of the mobile display device 13 such that the low-resolution entire picture is subjected to scaling and translation. Furthermore, in a case where a low-resolution entire picture in the display mode pursuant to the azimuthal equidistant projection has been displayed on the mobile display device 13, the user can perform operations to the touch panel display of the mobile display device 13 such that the low-resolution entire picture is subjected to scaling and spherical rotation. This arrangement enables the user to grasp the entire image of an entire celestial sphere exhibited by the low-resolution entire picture.

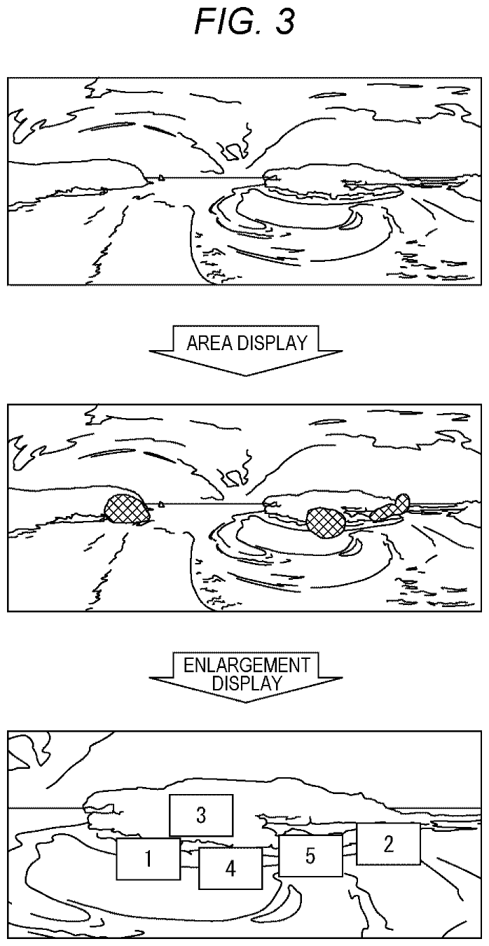

A user interface for selection of a high-resolution partial picture from a low-resolution entire picture, will be described with reference to FIG. 3.

For example, the mobile display device 13 acquires a low-resolution entire picture based on such equirectangular projection as illustrated in the upper part of FIG. 3 together with information regarding prepared high-resolution partial pictures (hereinafter, referred to as picture metadata). For example, as the picture metadata, the Media Presentation Description (MPD) of Moving Picture Experts Group Dynamic Adaptive Streaming over HTTP (MPEG DASH) can be used.

Then, on the basis of the picture metadata, the mobile display device 13 superimposition-displays high-resolution areas (hatched areas in the example of FIG. 3) on the low-resolution entire picture such that the areas where the high-resolution partial pictures are present are enclosed, as illustrated in the middle part of FIG. 3.

Moreover, when the user performs an operation to the touch panel display of the mobile display device 13 such that a high-resolution area is enlargement-displayed, the mobile display device 13 displays respective indices of high-resolution partial pictures selectably, as illustrated in the lower part of FIG. 3. In the example of FIG. 3, respective frames representing the high-resolution partial pictures are displayed at the locations at which the high-resolution partial pictures are disposed. The index numbers (1 to 5) are denoted in the frames.

Thus, when the user selects a desired high-resolution partial picture the user desires to view and listen to from the indices of the high-resolution partial pictures, the mobile display device 13 transmits a viewing/listening request for distribution of the high-resolution partial picture to the distribution server 15. When the distribution server 15 transmits the high-resolution partial picture in response to the viewing/listening request, the mobile display device 13 receives and displays the high-resolution partial picture, so that the user can view and listen to the desired high-resolution partial picture.

Moreover, in a case where the user desires to view and listen to another high-resolution partial picture, the user performs an operation similar to the above again after performing an operation of returning the display of the mobile display device 13 to the low-resolution entire picture, so that the user can selectively view and listen to the desired high-resolution partial picture.

As above, in the content distribution system 11, adoption of the user interface on which high-resolution areas are superimposition-displayed onto a low-resolution entire picture enables the user to recognize the areas where the high-resolution partial pictures are present before zooming the low-resolution entire picture. Therefore, in the content distribution system 11, the user can avoid performing a waste operation, such as zooming any area where no high-resolution partial pictures are present.

Therefore, in reproduction of content having a low-resolution entire picture and high-resolution partial pictures prepared, the content distribution system 11 enables the user to request distribution of a desired high-resolution partial picture, with favorable operability, resulting in improvement of user experience.

Note that the content distribution system 11 may adopt another user interface.

User interfaces for selection of a high-resolution partial picture from a low-resolution entire picture, according to modifications, will be described with

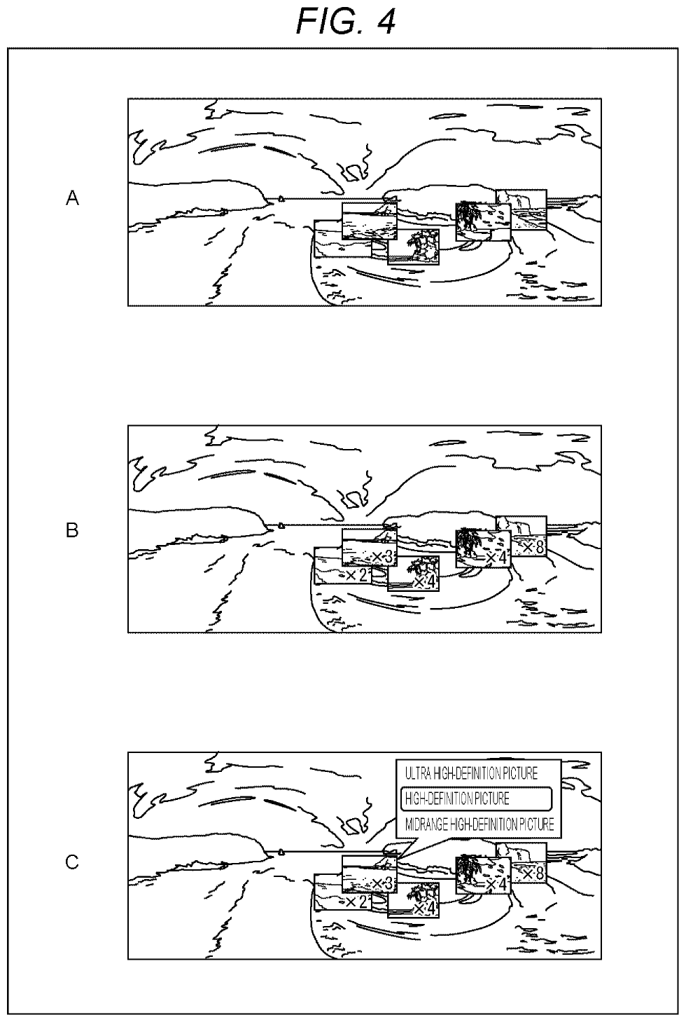

reference to FIGS. 4 to 6.

On the user interface illustrated in A of FIG. 4, at places at which a plurality of high-resolution partial pictures is present to a low-resolution entire picture, respective thumbnail images of the corresponding high-resolution partial pictures are displayed selectably. For example, the user performs a touch operation to any of the thumbnail images, so that the high-resolution partial picture to be displayed can be selected.

Furthermore, in addition to display of such thumbnail images, for example, respective indices of the high-resolution partial pictures denoted with such index numbers as illustrated in FIG. 3 may be displayed. As above, in a case where index numbers are used, for example, the high-resolution partial picture to be displayed can be sequentially selected in the order of index numbers.

Furthermore, regarding the place at which each high-resolution partial picture is present, in a case where a predetermined number of high-resolution partial pictures different in resolution (high-definition level) are present at the same place, as Illustrated in B of FIG. 4, in indicating the number of high-resolution part al pictures is denoted on each individual thumbnail image. That is, in B of FIG. 4, the thumbnail image denoted with “×2” indicates that two high-resolution partial pictures different in resolution. are present, and the thumbnail image denoted with “×3” indicates that three high-resolution partial pictures different in resolution are present.

Then, in a case where a predetermined number of high-resolution partial pictures different in resolution are present at the same place, use of such a user interface as illustrated in C of FIG. 4 enables any resolution to be selected for the high-resolution partial picture to be displayed. In the example illustrated in C of FIG. 4, a pop-up menu having popped up from the thumbnail image of a high-resolution partial picture indicates that, among three resolutions of an ultra high-definition picture, a high-definition picture, and a midrange high-definition picture, the high-definition picture has been selected.

Note that, for example, adopted may be a user interface on which respective thumbnail images of a predetermined number of high-resolution partial pictures are displayed in a multilayered mode and a desired-resolution high-resolution partial picture is specified by sequentially turning the thumbnail images from the top.

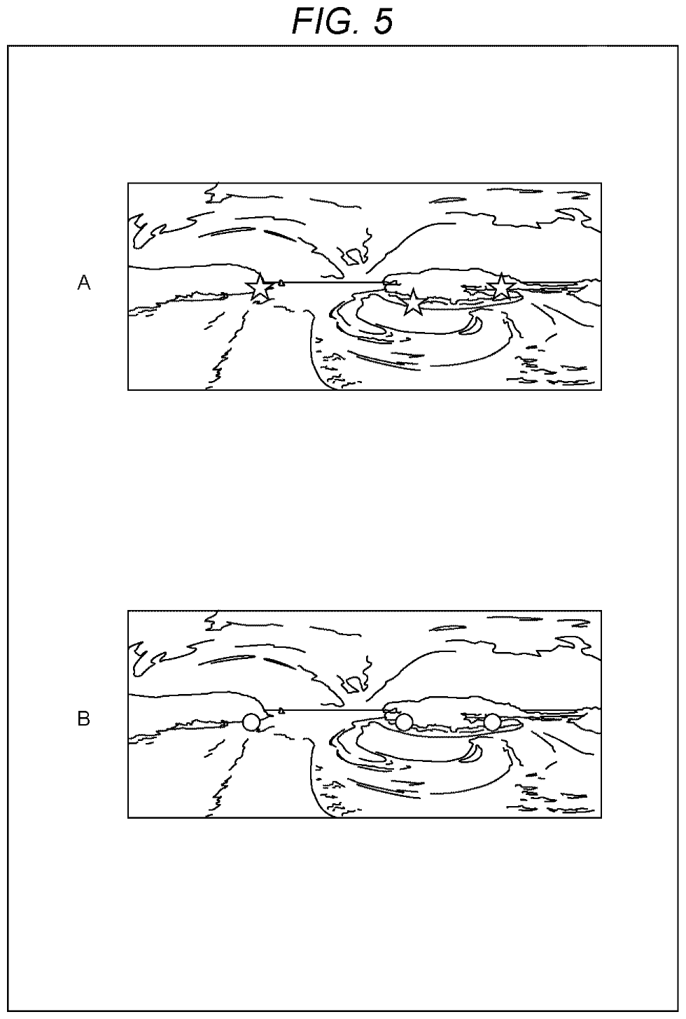

Furthermore, as illustrated in FIG. 5, markers based on luminance (e.g., brightness or difference in contrast) that a low-resolution entire picture does not have, may be displayed at places at which high-resolution partial pictures are present on the low-resolution entire picture. A of FIG. 5 exemplifies display of star markers, and B of FIG. 5 exemplifies circular markers. Moreover, the markers may blink on and off due to a special effect, resulting in being more noticeable.

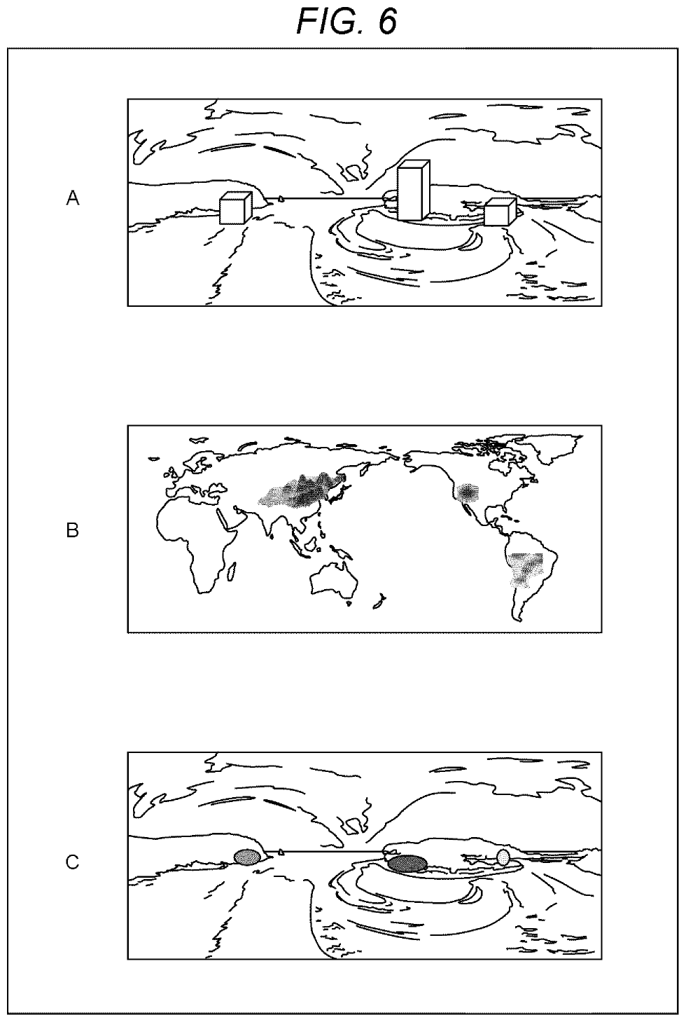

Furthermore, as illustrated in A of FIG. 6, in each area where high-resolution partial pictures are present, a shape (three-dimensionally bar-chart shape) representing height corresponding to the number of high-resolution partial pictures present in the corresponding area may be displayed on a low-resolution entire picture. Furthermore, as illustrated in B of FIG. 6, a so-called heat map indicating density such that an area including a large number of high-resolution partial pictures is deep and an area including a small number of high-resolution partial pictures light, may be displayed on a low-resolution entire picture.

Furthermore, as illustrated in C of FIG. 6, each high-resolution area in which the areas where high-resolution partial pictures are present are enclosed may be displayed, on a low-resolution entire picture, with depth (or brightness) corresponding to the number of high-resolution partial pictures present in the corresponding high-resolution area. For example, the deepest high-resolution area indicates the largest number of high-resolution partial pictures, the second deepest high-resolution area indicates the second largest number of high-resolution partial pictures, and the lightest high-resolution area indicates the smallest number of high-resolution partial pictures.

Then, when an operation of enlargement display is performed to such a low-resolution entire picture as illustrated in FIG. 5 or 6, frames representing respective high-resolution partial pictures, denoted with such index numbers as illustrated on the lower side of FIG. 3, are displayed selectably.

### Exemplary Configuration of Mobile Display Device

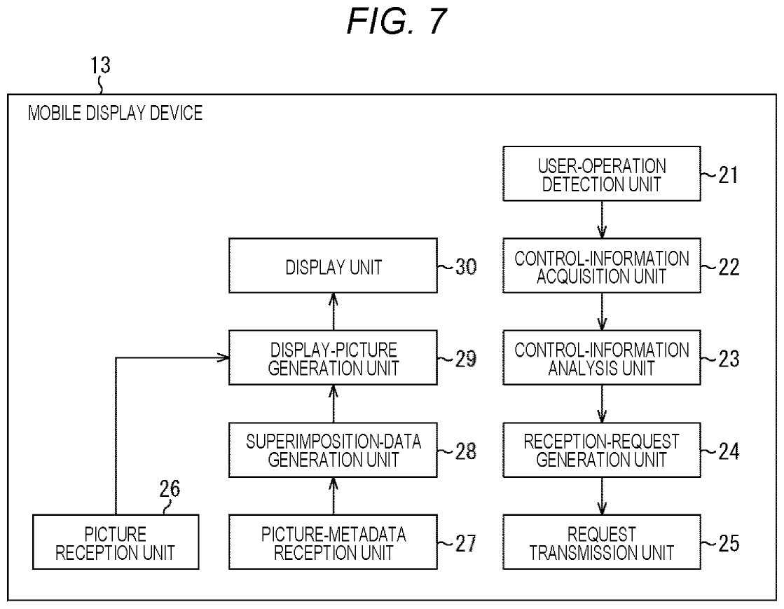

FIG. 7 is a block diagram of an exemplary configuration of the mobile display device 13.

As illustrated in FIG. 7, the mobile display device 13 includes a user-operation detection unit 21, a control-information acquisition unit 22, a control-information analysis unit 23, a reception-request generation unit 24, a request transmission unit 25, a picture reception unit 26, a picture-metadata reception unit 27, a superimposition-data generation unit 28, a display-picture generation unit 29, and a display unit 30.

The user-operation detection unit 21 is, for example, a touch-operation input sensor for the touch panel display. The user-operation detection unit 21 detects a user operation to the mobile display device 13 and notifies the control-information acquisition unit 22 of the user operation.

In accordance with the user operation from the user-operation detection unit 21, the control-information acquisition unit 22 acquires, for example, control information indicating user's operation description (e.g., enlargement display, selection of a high-resolution partial picture, or return to the low-resolution entire picture).

The control-information analysis unit 23 analyzes the control information acquired by the control-information acquisition unit 22 or picture metadata received by the picture-metadata reception unit 27.

The reception-request generation unit 24 generates a viewing/listening request for distribution of the high-resolution partial picture determined by the user operation. The request transmission unit 25 transmits the viewing/listening request generated by the reception-request generation unit 24, to the distribution server 15 through the network 12.

The picture reception unit 26 receives the low-resolution entire picture or the high-resolution partial picture transmitted from the distribution server 15 through the network 12 and then supplies the low-resolution entire picture or the high-resolution partial picture to the display-picture generation unit 29.

The picture-metadata reception unit 27 receives the picture metadata transmitted from the distribution server 15 through the network 12 and then supplies the picture metadata to the superimposition-data generation unit 28.

On the basis of the picture metadata received by the picture-metadata reception unit 27, the superimposition-data generation unit 28 generates superimposition data to be superimposed onto the low-resolution entire picture received by the picture reception unit 26. For example, the superimposition-data generation unit 28 generates, as the superimposition data, such high-resolution areas as illustrated in the middle part of FIG. 3, such indices of high-resolution partial pictures as illustrated in the lower part of FIG. 3, such thumbnail images of high-resolution partial pictures as illustrated in FIG. 4, or the like.

The display-picture generation unit 29 generates a display picture in which the low-resolution entire picture or the high-resolution partial picture received by the picture reception unit 26 is adapted to the size of view and resolution of the display unit 30, and then the display unit 30 displays the display picture. Furthermore, on the basis of the superimposition data generated by the superimposition-data generation unit 28, the display-picture generation unit 29 generates, for example, a display picture in which the high-resolution areas are superimposed on the low-resolution entire picture, a display picture in which the indices of the high-resolution partial pictures are superimposed on the low-resolution entire picture, a display picture in which the thumbnail images of the high-resolution partial pictures are superimposed on the low-resolution entire picture, or the like.

The display unit 30 is, for example, a display for the touch panel display, and displays the display picture generated by the display-picture generation unit. 29.

### First Content Distribution Processing

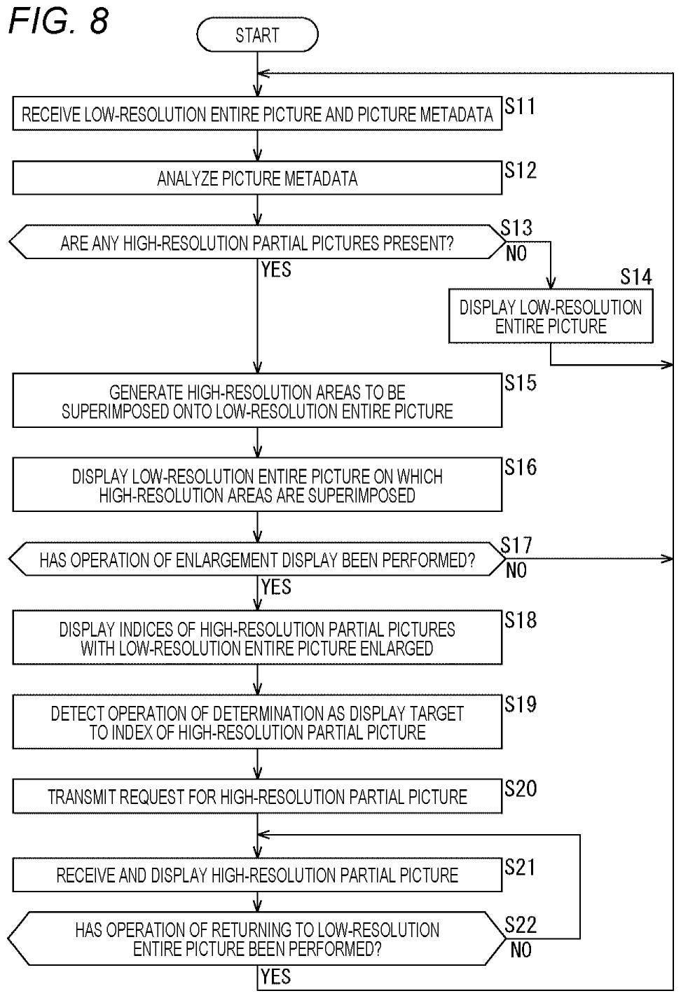

First content distribution processing that is performed in the content distribution system 11 will be exemplarily described with reference to a flowchart illustrated in FIG. 8.

In step S11, the picture reception unit 26 of the mobile display device 13 receives a low-resolution entire picture transmitted from the distribution server 15 and the picture-metadata reception unit 27 of the mobile display device 13 receives picture metadata transmitted from the distribution server 15.

In step 812, the control-information analysis unit 23 of the mobile display device 13 analyzes the picture metadata received by the picture-metadata reception unit 27 in step S11.

In step S13, in accordance with an analytical result from the control-information analysis unit 23 in step S12, the mobile display device 13 determines whether or not any hierarchically divided high-resolution partial pictures are present to the low-resolution entire picture received in step S11.

In step S13, in a case where the mobile display device 13 determines that no high-resolution partial pictures are present, the processing proceeds to step S14.

In step S14, the display-picture generation unit 29 of the mobile display device 13 generates a display picture such that the low-resolution entire picture received by the picture reception unit 26 in step S11 is adapted to the size of view and resolution of the display unit 30. Then, after the display unit 30 of the mobile display device 13 displays the low-resolution entire picture, the processing goes back to step S11. After that, similar processing is repeatedly performed.

Meanwhile, in step S13, in a case where the mobile display device 13 determines that high-resolution partial pictures are present, the processing proceeds to step S15.

In step S15, on the basis of the picture metadata received by the picture-metadata reception unit 27 in step S11, the superimposition-data generation unit 28 of the mobile display device 13 generates, as superimposition data, high-resolution areas to be superimposed onto the low-resolution entire picture.

In step S16, the display-picture generation unit 29 of the mobile display device 13 generates a display picture in which the high-resolution areas based on the superimposition data generated by the superimposition-data generation unit 28 are superimposed on the low-resolution entire picture received by the picture reception unit 26. Thus, the mobile display device 13 can display, on the display unit 30, the low-resolution entire picture on which the high-resolution areas are superimposed, as illustrated in the middle part of FIG. 3. Therefore, in a case where the user desires to view and listen to a high-resolution partial picture in a high-resolution area, the user can perform an operation of enlargement-displaying the high-resolution area.

In step S17, on the basis of control information acquired by the control-information acquisition unit 22 in accordance with a user operation detected by the user-operation detection unit 2, the mobile display device 13 determines whether or not an operation of enlargement-displaying a high-resolution area has been performed.

In step 317, in a case where the mobile display, device 13 determines that no operation of enlargement-displaying a high-resolution area has been performed, the processing goes back to step S11. After that, similar processing is repeatedly performed. Meanwhile, in step S17, in a case where the mobile display device 13 determines that an operation of enlargement-displaying a high-resolution area has been performed, the processing proceeds to step S18.

In step S18, in accordance with the user operation detected by the user-operation detection unit 21, the display-picture generation unit 29 of the mobile display device 13 generates a display picture such that the low-resolution entire picture is enlarged and additionally respective indices of the high-resolution partial pictures are displayed. Thus, the mobile display device 13 can display the indices of the high-resolution partial pictures selectably on the display unit 30, as illustrated in the lower part of FIG. 3. Therefore, the user can perform an operation of selecting any of the indices of the high-resolution partial pictures.

In step S19, on the basis of control information. acquired by the control-information acquisition unit 22 in accordance with a user operation detected by, the user-operation detection unit 21, the mobile display device 13 detects an operation of determination as the display target to the index of a high-resolution partial picture.

In step S20, the reception-request generation unit 24 of the mobile display device 13 generates a viewing/listening request for distribution of the high-resolution partial picture determined by the user operation detected in step 819. Then, the request transmission unit 25 of the mobile display device 13 transmits the viewing/listening request to the distribution server 15.

In step S21, the picture reception unit 26 of the mobile display device 13 receives the high-resolution partial picture transmitted from the distribution server 15 in response to the viewing/listening request transmitted in step S20. Then, the display-picture generation unit 29 of the mobile display device 13 generates a display picture such that the high-resolution partial picture is adapted to the size of view and resolution of the display unit 30, and then the display unit 30 displays the high-resolution partial picture.

In step S822, on the basis of control information acquired by the control-information acquisition unit 22 in accordance with a user operation detected by the user-operation detection unit 21, the mobile display device 13 determines whether or not an operation of returning to the low-resolution entire picture has been performed.

In step S22, in a case where the mobile display device 13 determines that no operation of returning to the low-resolution entire picture has been performed, the processing goes back to step S21, so that the high-resolution partial picture remains displayed.

Meanwhile, in step S22, in a case where the mobile display device 13 determines that an operation of returning to the low-resolution entire picture has been performed, the processing goes back to step S11. After that, similar processing is repeatedly performed.

In the first content distribution processing as above, distribution control of content and display of a high-resolution partial picture are both performed in the mobile display device 13. Then, through the user interface on which high-resolution areas are superimposition-displayed onto a low-resolution entire picture, the user performs an operation of enlargement-displaying a high-resolution area, so that the user can view and listen to a desired high-resolution partial picture due to a simple operation.

### Second Content Distribution Processing

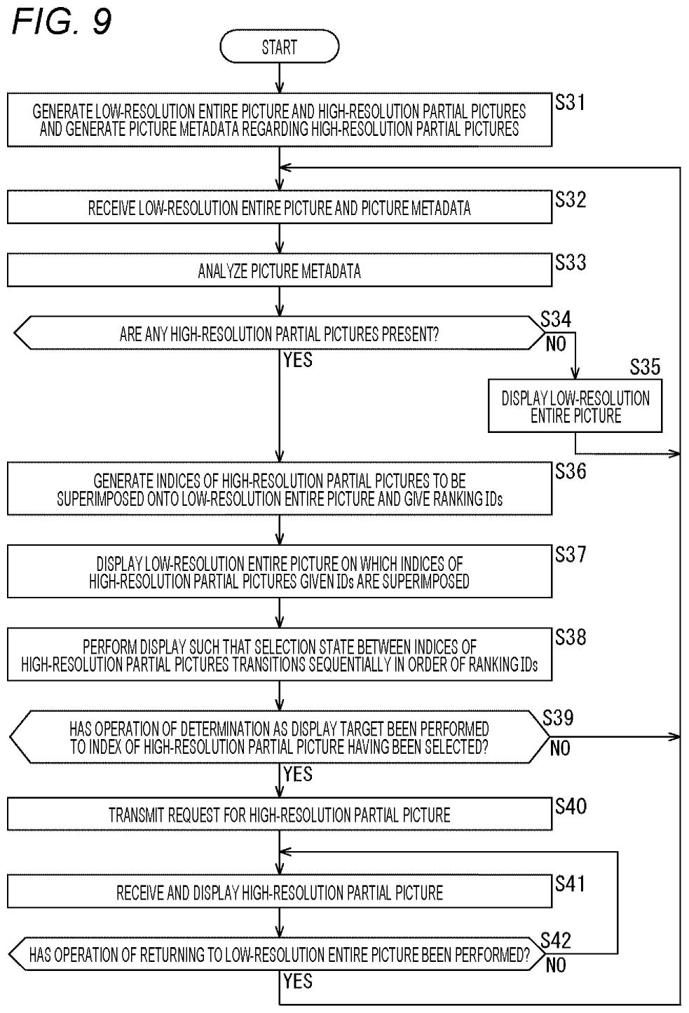

Second content distribution processing that is performed in the content distribution system 11 will be exemplarily described with reference to a flowchart illustrated in. FIG. 9.

In step S31, the distribution server 15 generates a low-resolution entire picture and high-resolution partial pictures and generates picture metadata regarding the high-resolution partial pictures. In this case, the picture metadata includes identifications (IDs) that rank the high-resolution partial pictures.

Processing similar to that in steps S11 to S14 of FIG. 8 is performed in steps S32 to S35.

Then, in step S36, on the basis of the picture metadata received by the picture-meta data reception unit 27 in step S32, the superimposition-data generation unit 28 of the mobile display device 13 generates, as superimposition data, respective indices of high-resolution partial pictures to be superimposed on the low-resolution entire picture. Moreover, the mobile display device 13 gives the indices the corresponding ranking IDs. The IDs are linked with the indices.

In step S37, the display-picture generation unit 29 of the mobile display device 13 generates a display picture in which the indices of the high-resolution partial pictures given the IDs based on the superimposition data generated by the superimposition-data generation unit 28 are superimposed on the low-resolution entire picture received by the picture reception unit 26. Thus, the mobile display device 13 can display, on the display unit 30, the low-resolution entire picture on which the indices of the high-resolution partial pictures given the IDs are superimposed.

In step S38, on the basis of a user operation detected by the user-operation detection unit 21, the mobile display device 13 performs display such that the selection state between the indices of the high-resolution partial pictures transitions sequentially in the order of the ranking IDs.

In step S39, in accordance with a user operation detected by the user-operation detection unit 21, the mobile display device 13 determines whether or not an operation of determination as the display target has been performed to the index of a high-resolution partial picture having been selected.

In step S39, in a case where the mobile display device 13 determines that no operation of determination as the display target has been performed, the processing goes back to step S32. After that, similar processing is repeatedly performed. Meanwhile, in step 339, in a case where the mobile display device 13 determines that an operation of determination as the display target has been performed, the processing proceeds to step S40.

After that, processing similar to that in steps 320 to 322 of FIG. 8 is performed in steps 340 to S42.

In the second content distribution processing as above, distribution control of content and display of a high-resolution partial picture are both performed in the mobile display device 13. Then, through the user interface on which the indices of high-resolution partial pictures are superimposition-displayed onto a low-resolution entire picture, the user performs operations of sequential selection pursuant to IDs and determination, so that the user can view and listen to a desired high-resolution partial picture due to a simple operation.

### Third Content Distribution Processing

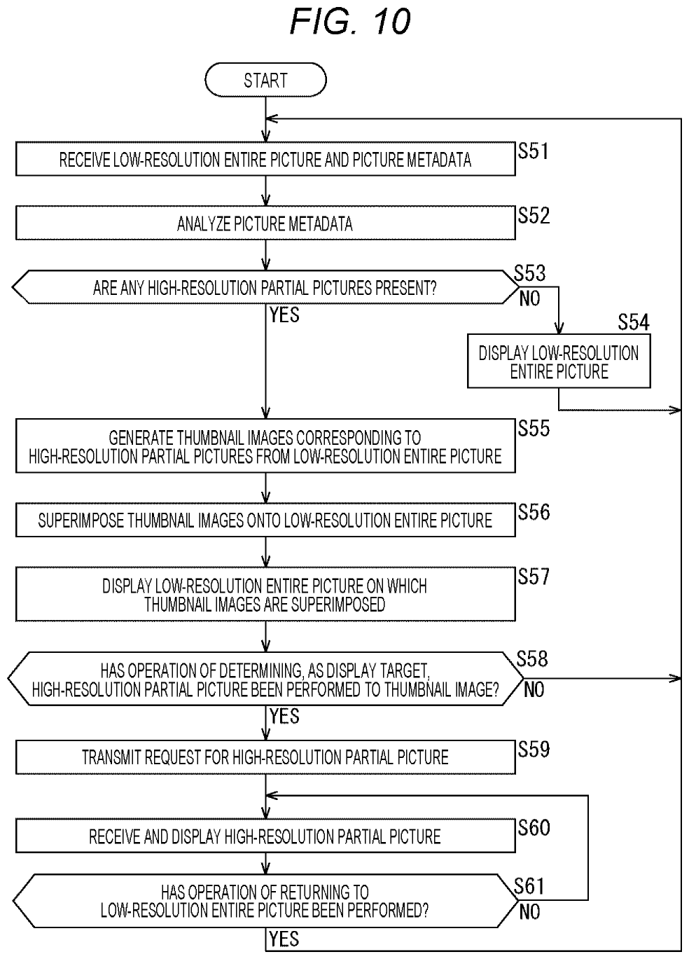

Third content distribution processing that is performed in the content distribution system 11 will be described with reference to a flowchart illustrated in FIG. 10.

Processing similar to that in steps S11 to S14 of FIG. 8 is performed in steps S51 to S54.

Then, in step S55, on the basis of the picture metadata received by the picture-metadata reception unit 27 in step S51, the superimposition-data generation unit 28 of the mobile display device 13 generates, as superimposition data, respective thumbnail images of high-resolution partial pictures from a low-resolution entire picture. For example, the superimposition-data generation unit 28 extracts, from the low-resolution entire picture, the images corresponding to the locations at which the high-resolution partial pictures are present, and adjusts the sizes of the images to the sizes of thumbnail images, so that the thumbnail images can be generated.

In step S56, the display-picture generation unit 29 of the mobile display device 13 generates a display picture in which. the thumbnail images based on the superimposition data generated by the superimposition-data generation unit 26 are superimposed on the low-resolution entire picture received by the picture reception unit 26.

In step S57, the mobile display device 13 displays, on the display unit 30, the low-resolution entire picture on which the thumbnail images are superimposed, as described with reference to FIG. 4. Therefore, in a case where the user desires to view and listen to a high-resolution partial picture among the thumbnail images, the user can perform an operation of selecting the thumbnail image of the high-resolution partial picture.

In step S58, in accordance with a user operation detected by the user-operation detection unit 21, the mobile display device 13 determines whether or not an operation of determining, as the display target, a high-resolution partial picture has been performed to a thumbnail image.

In step S58, in a case where the mobile display device 13 determines that no operation of determination as the display target has been performed, the processing goes back to step S51. After that, similar processing is repeatedly performed. Meanwhile, in step S58, in a case where the mobile display device 13 determines that an operation of determination as the display target has been performed, the processing proceeds to step S59.

After that, processing similar to that in steps S20 to S22 of FIG. 8 is performed in steps S59 to S61.

In the third content distribution processing as above, distribution control of content and display of a high-resolution partial picture are both performed in the mobile display device 13. Then, through the user interface on which the thumbnail images of high-resolution partial pictures generated in the mobile display device 13 are superimposition-displayed onto a low-resolution entire picture, the user can view and listen to a desired high-resolution partial picture due to a simple operation.

### Fourth Content Distribution Processing

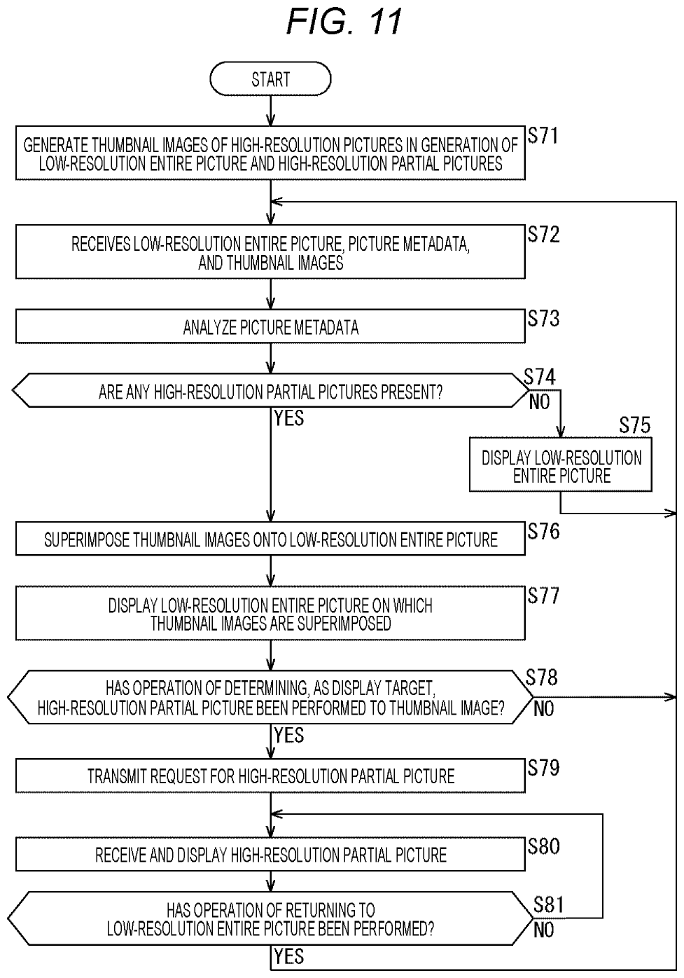

Fourth content distribution processing that is performed in the content distribution system 11 will be exemplarily described with reference to a flowchart illustrated in FIG. 11.

In step S71, the distribution server 15 generates, in generation of a low-resolution entire picture and high-resolution partial pictures, respective thumbnail images of the high-resolution partial pictures.

In step S72, the picture reception unit 26 of the mobile display devices 13 receives the low-resolution entire picture transmitted from the distribution server 15, and the picture-metadata reception unit 27 of the mobile display device 13 receives picture metadata transmitted from the distribution server 15. Moreover, the picture-metadata reception unit 27 of the mobile display device 13 receives the thumbnail images of the high-resolution partial pictures transmitted from the distribution server 15.

Processing similar to that in steps S12 to S14 of FIG. 8 is performed in steps S73 to S75.

Then, in step S76, the display-picture generation. unit 29 of the mobile display device 13 generates a display picture in which the thumbnail images of high-resolution partial pictures received by the picture-metadata reception unit 27 in step S72 are superimposed on the low-resolution entire picture received by the picture reception unit 26.

In step S77, the mobile display. device 13 displays, on the display unit 30, the low-resolution entire picture on which the thumbnail images are superimposed, as described with reference to FIG. 4. Therefore, in a case where the user desires to view and listen to a high-resolution partial picture among the thumbnail images, the user can perform an operation of selecting the thumbnail image of the high-resolution partial picture.

In step S78, in accordance with a user operation detected by the user-operation detection unit 21, the mobile display device 13 determines whether or not an operation of determining, as the display target, a high-resolution partial picture has been performed to a thumbnail image.

In step S78, in a case where the mobile display device 13 determines that no operation of determination as the display target has been performed, the processing goes back to step S72. After that, similar processing is repeatedly performed. Meanwhile, in step S78, in a case where the mobile display device 13 determines that an operation of determination as the display target has been performed, the processing proceeds to step S79.

After that, processing similar to that in steps S20 to S22 of FIG. 8 is performed in step S79 to S81.

In the fourth content distribution processing as above, distribution control of content and display of a high-resolution partial picture are both performed in the mobile display device 13. Then, through the user interface on which the thumbnail images of high-resolution partial pictures generated in the distribution server 15 are superimposition-displayed on a low-resolution entire picture, the user can view and listen to a desired high-resolution partial picture due to a simple operation.

### Fifth Content Distribution Processing

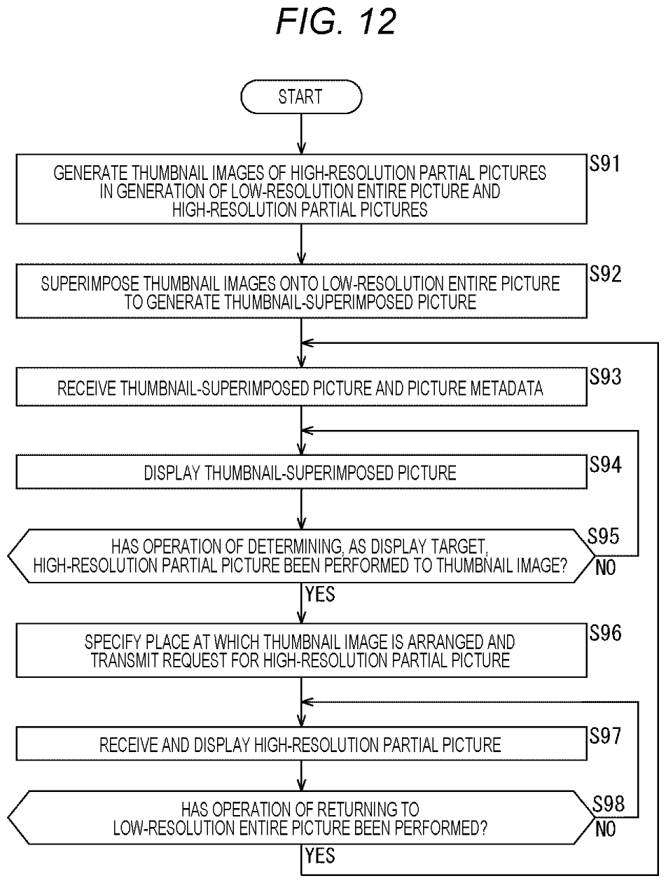

Fifth content distribution processing that is performed in the content distribution system 11 will be exemplarily described with reference to a flowchart illustrated in FIG. 12.

In step S91, the distribution server 15 generates, in generation of a low-resolution entire picture and high-resolution partial pictures, respective thumbnail images of the high-resolution partial pictures.

In step S92, the distribution server 15 generates one combined picture in which the thumbnail images of the high-resolution partial pictures are superimposed on proper locations on the low-resolution entire picture (hereinafter, referred to as a thumbnail-superimposed picture).

In step S93, the picture reception unit 26 of the mobile display device 13 receives the thumbnail-superimposed picture transmitted from the distribution server 15, and the picture-metadata reception unit 27 of the mobile display device 13 receives picture metadata transmitted from the distribution server 15.

In step S94, the display-picture generation unit 29 of the mobile display device 13 generates a display picture such that the thumbnail-superimposed picture received by the picture reception unit 26 in step S93 is adapted to the size of view and resolution of the display unit 30. Then, the mobile display device 13 displays the thumbnail-superimposed picture on the display unit 30.

In step S95, in accordance with a user operation detected by the user-operation detection unit 21, the mobile display device 13 determines whether or not an operation of determining, as the display target, a high-resolution partial picture has been performed to a thumbnail image.

In step S95, in a case where the mobile display device 13 determines that no operation of determination as the display target has been performed, the processing goes back to step S94, so that the thumbnail-superimposed picture remains displayed. Meanwhile, in step S95, in a case where the mobile display device 13 determines that an operation of determination as the display target has been performed, the processing proceeds to step S96.

In step S96, the mobile display device 13 specifies the display place of the thumbnail image determined as the display target, and the reception-request generation unit 24 generates a viewing/listening request for distribution of the high-resolution partial picture corresponding to the thumbnail image. Then, the request transmission unit 25 of the mobile display device 13 transmits the viewing/listening request to the distribution server 15.

After that, processing similar to that in steps S21 and S22 of FIG. 8 is performed in steps S97 and S98.

In the fifth content distribution processing as above, distribution control of content and display of a high-resolution partial picture are both performed in the mobile display device 13. Then, through the user interface on which a thumbnail-superimposed picture generated in the distribution server 15 is displayed, the user can view and listen to a desired high-resolution partial picture due to a simple operation.

### Modifications in Case Where No High-Resolution Partial Pictures Are Present

For example, in a case where it is determined that no high-resolution partial pictures are present in step S13 of FIG. 8 described above, the low resolution entire picture is displayed in step S14. In contrast to this, in a case where no high-resolution partial pictures are present, instead of the processing in step S14, processing of requesting generation of a high-resolution partial picture can be performed. Furthermore, in step S35 of FIG. 9, step S54 of FIG. 10, and step S75 of FIG. 11, similarly, processing of requesting generation of a high-resolution partial picture can be performed.

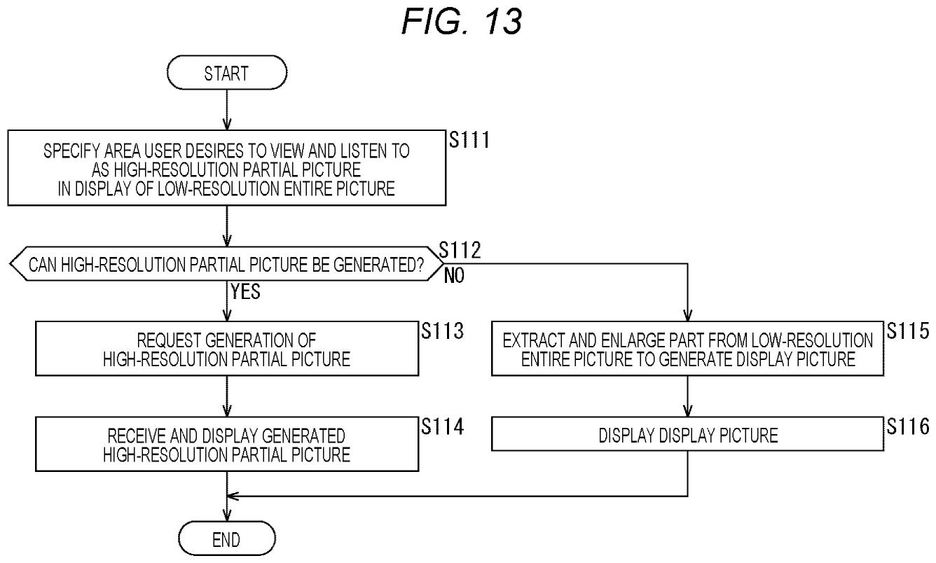

FIG. 13 is an explanatory flowchart of processing of requesting generation of a high-resolution partial picture in a case where no high-resolution partial pictures are present.

For example, in a case where it is determined that no high-resolution partial pictures are present in step S13 of FIG. 8, the processing starts. In step S111, the mobile display device 13 specifies an area the user desires to view and listen to as a high-resolution partial picture in the display of the low-resolution entire picture.

In step S112, with reference to the picture metadata of content being reproduced, the mobile display device 13 determines whether or not a high-resolution partial picture can be generated for the area the user desires to view and listen to as a high-resolution partial picture.

In step S112, in a case where the mobile display device 13 determines that a high-resolution partial picture can be generated for the area the user desires to view and listen to as a high-resolution partial picture, the processing proceeds to step S113.

In step S113, on the basis of information regarding the area the user desires to view and listen to as a high-resolution partial picture, the reception-request generation unit 24 of the mobile display device 13 generates a viewing/listening request for generation and distribution of the high-resolution partial picture. Then, the request transmission unit 25 of the mobile display device 13 transmits the viewing/listening request to the distribution server 15.

The distribution server 15 generates the high-resolution partial picture on the basis of the viewing/listening request, and transmits the high-resolution partial picture to the mobile display device 13.

In step S114, the picture reception unit 26 of the mobile display device 13 receives the high-resolution partial picture generated by the distribution server 15. Then, the display-picture generation unit 29 of the mobile display device 13 generates a display picture such that the high-resolution partial picture is adapted to the size of view and resolution of the display unit 30, and then the display unit 30 displays the high-resolution partial picture.

Meanwhile, in step S112, in a case where the mobile display device 13 determines that no high-resolution partial picture can be generated for the area the user desires to view and listen to as a high-resolution partial picture, the processing proceeds to step S115.

In step S115, the mobile display device 13 extracts, from the low-resolution entire picture, the part corresponding to the area the user desires to view and listen to as a high-resolution partial picture, and the display-picture generation unit 29 Generates a display picture such that the part is enlarged.

In step S116, the mobile display device 13 displays, on the display unit 30, the display picture generated in step S115.

After the processing in step S114 or S116, for example, the processing proceeds to step S22 of FIG. 8. Then, it is determined whether or not an operation of returning to the low-resolution entire picture has been performed. After that, similar processing is repeatedly performed.

In the processing as above, even in a case where an area where no high-resolution partial picture is present is selected, the mobile display device 13 requests generation of a high-resolution partial picture or enlarges the low-resolution entire picture, so that the content can remain reproduced.

### Sixth Content Distribution Processing

As described above with reference to FIG. 1, in the content distribution system 11, in a case where distribution control of content and display of a high-resolution partial picture are performed by different pieces of equipment, an operation of selecting a high-resolution partial picture is performed in the mobile display device 13, and the large-screen display device 14 displays the high-resolution partial picture.

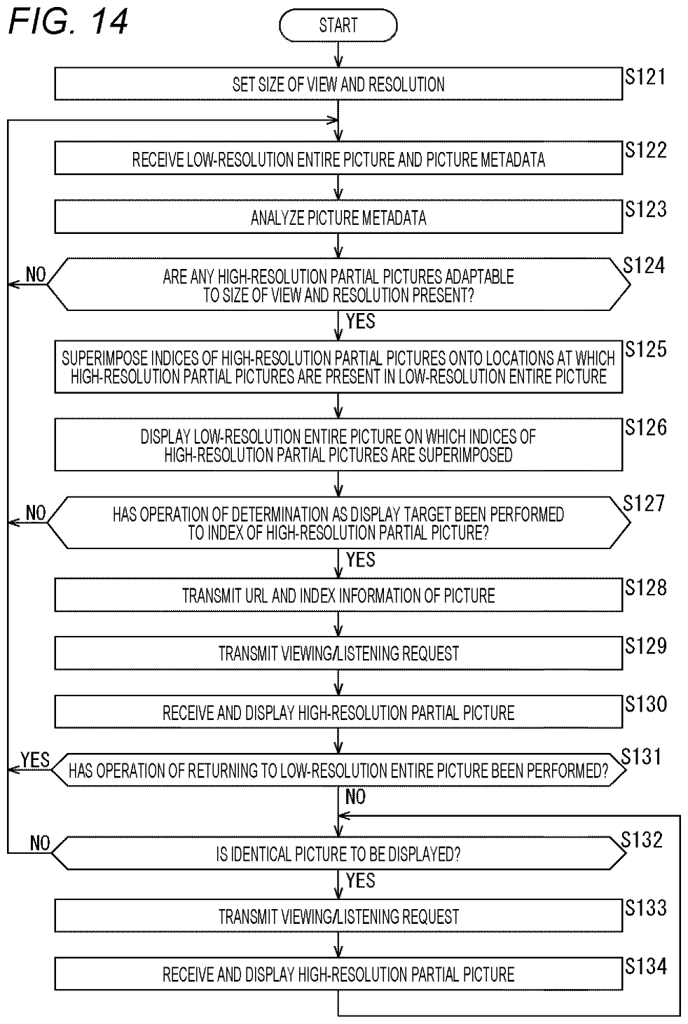

Sixth content distribution processing that is performed in the content distribution system 11, namely, processing in which distribution control of content and display of a high-resolution partial picture are performed by different pieces of equipment, will be exemplarily described with reference to a flowchart illustrated in FIG. 14.

In step S121, the size of view and resolution of the large-screen display device 14 are set to the mobile display device 13.

In step S122, the picture reception unit 26 of the mobile display device 13 receives a low-resolution entire picture transmitted from the distribution server 15, and the picture-metadata reception unit 27 of the mobile display device 13 receives picture metadata transmitted from the distribution server 15.

In step S123, the control-information analysis unit 23 of the mobile display device 13 analyzes the picture metadata received by the picture-metadata reception unit 27 in step S122.

In step S124, in accordance with an analytical result from the control-information analysis unit 23 in step S123, the mobile display device 13 determines whether or not any high-resolution partial pictures adaptable to the size of view and resolution of the large-screen display device 14 are present.

In step S124, in a case where the mobile display device 13 determines that no high-resolution partial pictures adaptable to the size of view and resolution of the large-screen display device 14 are present, the processing goes back to step S112. After that, similar processing is repeatedly performed.

Meanwhile, in step, S124, in a case where the mobile display device 13 determines that high-resolution partial pictures adaptable to the size of view and resolution of the large-screen display device 14 are present, the processing proceeds to step S125.

In step S125, the superimposition-data generation unit 28 of the mobile display device 13 generates, as superimposition data, respective indices of the high-resolution partial pictures to be superimposed onto the locations where the high-resolution partial pictures are present in the low-resolution entire picture.

In step S126, the mobile display device 13 displays, on the display unit 30, the low-resolution entire picture on which the indices of the high-resolution partial pictures are superimposed.

In step S127, in accordance with a user operation detected by the user-operation detection unit 21, the mobile display device 13 determines whether or not an operation of determination as the display target has been performed to the index of a high-resolution partial picture having been selected.

In step S127, in a case where the mobile display device 13 determines that no operation of determination as the display target has been performed, the processing goes back to step S122. After that, similar processing is repeatedly performed. Meanwhile, in step S127, in a case where the mobile display device 13 determines that an operation of determination as the display target has been performed, the processing proceeds to step S128.

In step S128, the mobile display device 13 transmits, to the large-screen display device 14, the uniform resource locator (URL) and index information of the high-resolution picture determined as the display target.

In step S129, on the basis of the URL and index information of the high-resolution partial picture, the large-screen display device 14 transmits, to the distribution server 15, a viewing/listening request for distribution of the high-resolution partial picture.

In step S130, the large-screen display' device 14 receives and displays the high-resolution partial picture transmitted from the distribution server 15 in response to the viewing/listening request transmitted in step S129.

In step S131, on the basis of control information.

acquired by the control-information acquisition unit 22 in accordance with a user operation detected by the user-operation detection unit 21, the mobile display device 13 determines whether or not an operation of returning to the low-resolution entire picture has been performed.

In step S131, in a case where the mobile display device 13 determines that an operation of returning to the low-resolution entire picture has been performed, the processing goes back to step S122. After that, similar processing is repeatedly performed.

Meanwhile, in step S131, in a case where the mobile display device 13 determines that no operation of returning to the low-resolution entire picture has been performed, the processing proceeds to step S132.

In step S132, the mobile display device 13 determines whether or not to display, on the display unit 30, a high-resolution partial picture identical to the high-resolution partial picture displayed on the large-screen display device 14.

In step S132, in a case where the mobile display device 13 determines not to display an identical picture on the display unit 30, the processing goes back to step

S122, and the High-resolution partial picture remains displayed.

Meanwhile, in step S132, is a case where the mobile display device 13 determines to display an identical picture on the display unit 30, the processing proceeds to step S133.

In step S133, the request transmission unit 25 of the mobile display device 13 transmits, to the distribution server 15, a viewing/listening request identical to that transmitted by the large-screen display device 14.

In step S134, the picture reception unit 26 of the mobile display device 13 receives the high-resolution partial picture transmitted from the distribution server 15 in response to the viewing/listening request transmitted in step S133, and then the display unit 30 displays the high-resolution partial picture.

After the processing in step S134, the processing goes back to step S132. After that, similar processing is repeatedly performed.

In the sixth content distribution processing as above, the mobile display device 13 performs distribution control of content, and the large-screen display device 14 performs display of a high-resolution partial picture. Thus, the user can view and listen to a desired high-resolution partial picture displayed on the large-screen display device 14 due to a simple operation.

### Second Exemplary Configuration of Content Distribution System

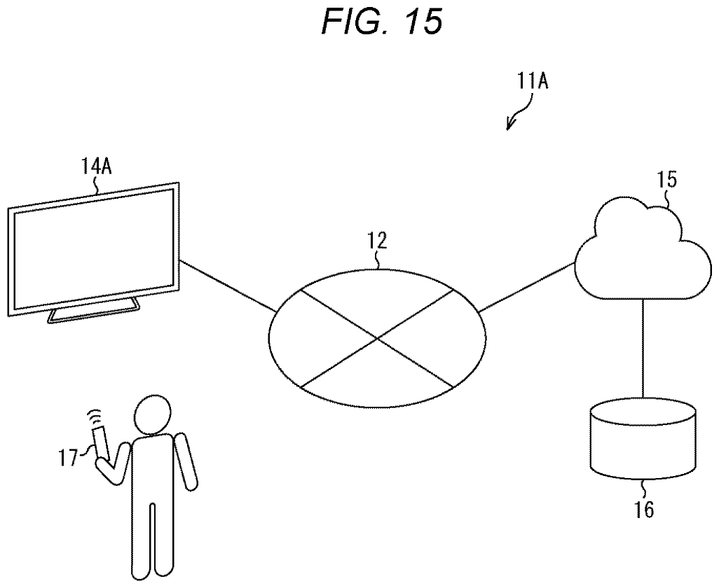

FIG. 15 is a block diagram of an exemplary configuration of a content distribution system according to a second embodiment to which the present technology is applied. Note that constituents in the content distribution system 11A illustrated in FIG. 15 resembling those in the content distribution system 11 of FIG. 1 are denoted with the same reference signs, and the detailed descriptions thereof will be omitted.

As illustrated in FIG. 15, the content distribution system 11A resembles the content distribution system 11 of FIG. 1 in that a distribution server 15 is connected to a network 12 and the distribution server 15 is connected with a content storage unit 16. Meanwhile, the content distribution system 11A is different from the content distribution system 11 of FIG. 1 in that a large-screen display device 14A is connected to the network 12 and a user performs, with a remote controller 17, an operation to content.

The large-screen display device 14A is, for example, a large-size display device capable of displaying a high-definition picture. The large-screen display device 14A is capable of performing communication with the distribution server 15 through the network 12.

The remote controller 17 is equipment for operation to content that the large-screen display device 14A reproduces. As the remote controller 17, a remote controller for a general television receiver can be used.

In the content distribution system 11A having such a configuration, in a case where a picture reproduction system built in the large-screen display device 14A recognizes that a picture to be reproduced is an entire celestial sphere, an operation guide enabling spatial control of the picture is displayed on the screen of the large-screen display device 14A. Then, functions for control and display of the spatial direction of the picture are allocated to buttons of the remote controller 17. This arrangement enables the user to operate the remote controller 17 such that temporal control or temporal and spatial control is performed to content that the large-screen display device 14A reproduces.

### Exemplary Operations to Content

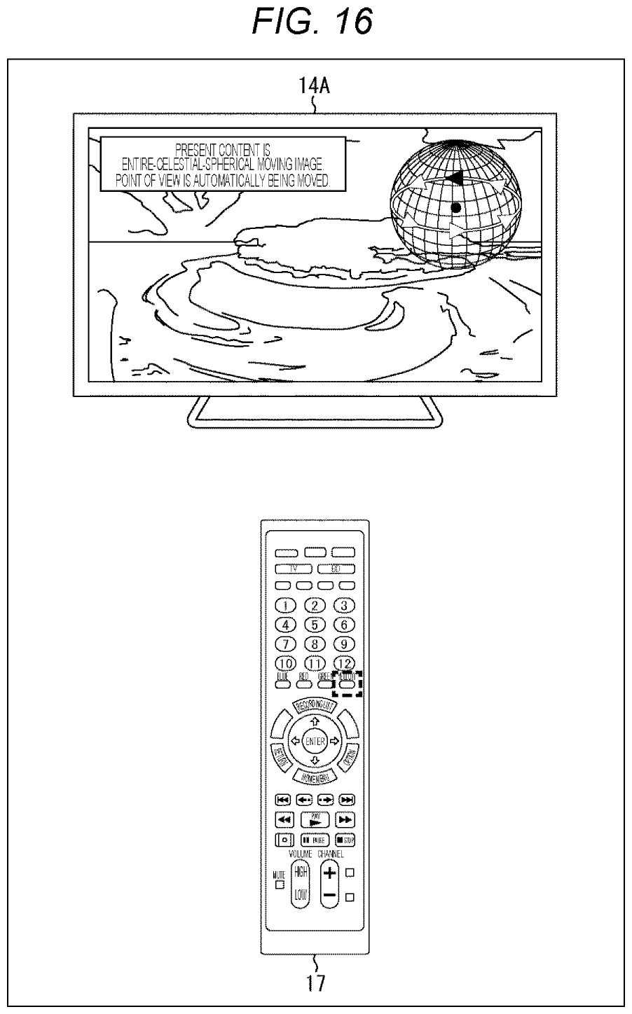

Exemplary operations to content with the remote controller 17 will be described with reference to FIGS. 16 to 20.

FIG. 16 illustrates a first exemplary operation of automatic movement of the line-of-sight to a low-resolution entire picture with a specific button kept pressed down.

As illustrated in FIG. 16, an operation guide with an entire-celestial-spherical model is displayed on the screen of the large-screen display device 14A. The message “the present content is an entire-celestial-spherical moving image. The point of view is automatically being moved” is displayed. Then, the locus of automatic movement of the point of view (solid-white arrows) is displayed and the current location of the point of view (black triangle) is displayed on the entire-celestial-spherical model displayed as the operation guide.

For example, a function of moving the point of view in accordance with a specific locus of an entire-celestial-spherical picture with a button kept pressed down and stopping the point of view with the button released, is allocated to a specific button of the remote controller 17 (button enclosed with a thick broken line in the example of FIG. 16).

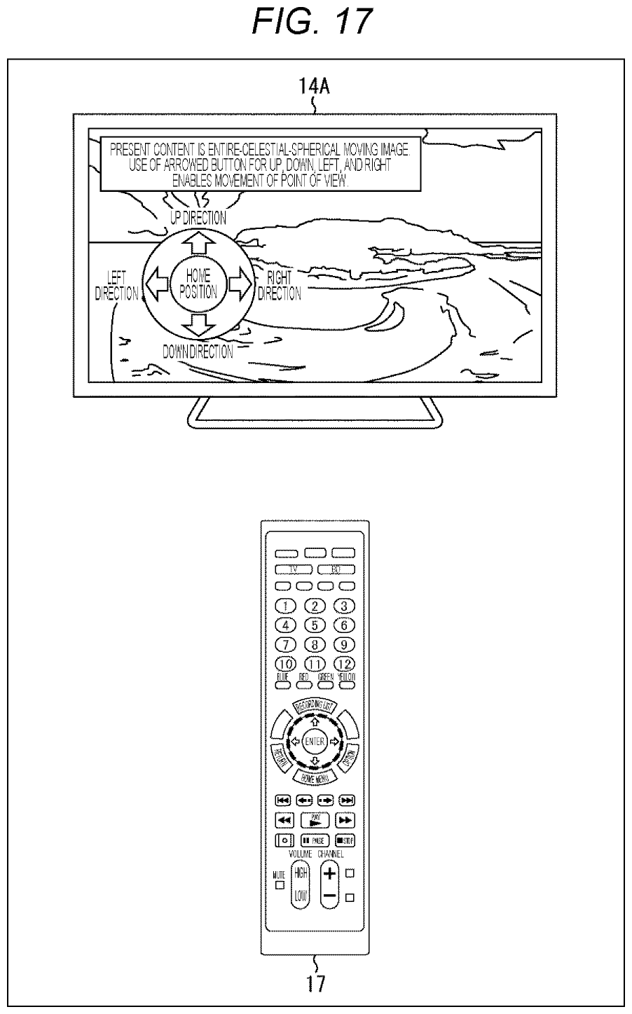

FIG. 17 illustrates a second exemplary operation of arbitrary movement of the line-of-sight to a low-resolution entire picture with a button for specifying a direction.

As illustrated in FIG. 17, an operation guide indicating a method of operating an arrowed button is displayed on the screen of the large-screen display device 14A. The message “the present content is an entire-celestial-spherical moving image. Use of the arrowed button for up, down, left, and right enables movement of the point of view” is displayed.

For example, a function of moving the point of view up, down, left, and right is allocated to the arrowed button for up, down, left, and right of the remote controller 17 enclosed with a thick broken line. Furthermore, a function of moving the point of view to the home position is allocated to the enter button arranged at the center of the arrowed button for up, down, left, and right of the remote controller 17.

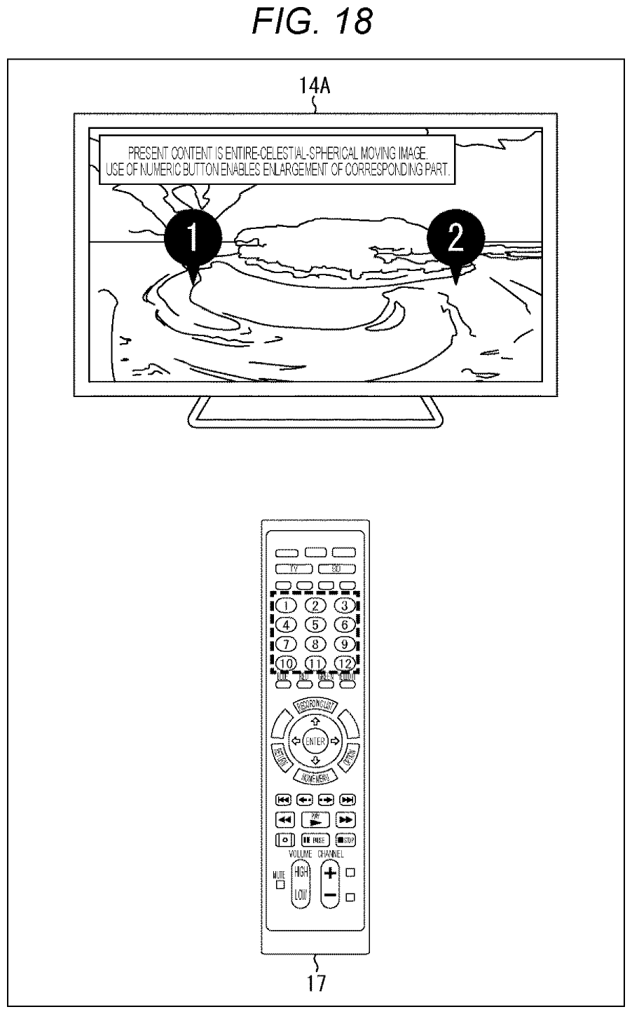

FIG. 18 illustrates a third exemplary operation of enlargement of a predetermined place in a low-resolution entire picture with buttons for specifying numbers.

As illustrated in FIG. 18, an operation guide ndicating directions in which movement can be made with numbers (1 and 2 in the example of FIG. 18) is displayed on the screen of the large-screen display device 14A. The message “the present content is an entire-celestial-spherical moving image. Use of a numeric button enables enlargement of the corresponding part” is displayed.

For example, a function of enlargement-displaying respective locations associated with numeric buttons is allocated to the numeric buttons of the remote controller 17 enclosed with a thick broken line. That is pressing the numeric button for 1 down causes movement of the point of view to “1” in the operation guide displayed on the screen of the large-screen display device 14A resulting in enlargement and display, and pressing the numeric button for 2 down causes movement of the point of view to “2” in the operation guide displayed on the screen of the large-screen display device 14A, resulting in enlargement and display.

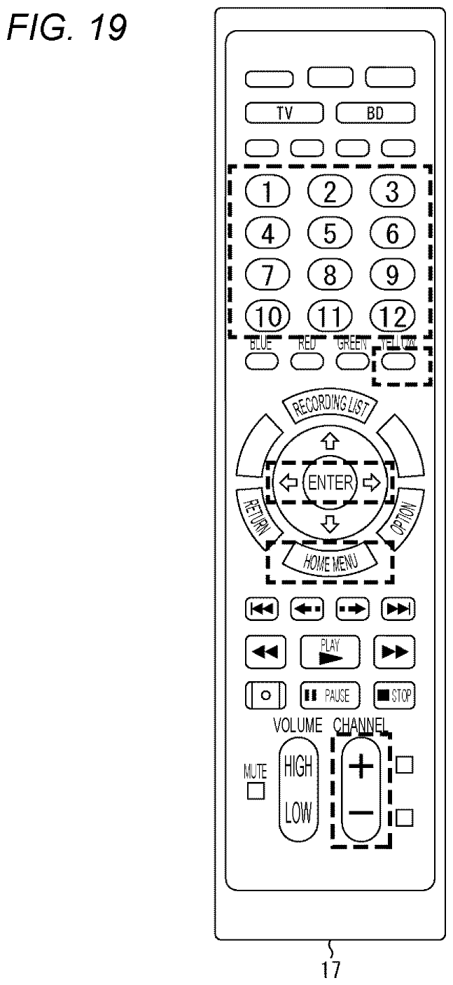

Exemplary allocation of functions to existing buttons arranged in the remote controller 17 will be described with reference to FIG. 19.

For example, as described with reference to FIG. 18, a function of moving the point of view to a number in the operation guide displayed on the large-screen display device 14A, is allocated to the numeric buttons of the remote controller 17.

Furthermore, as described with reference to FIG. 16, a function of automatically moving the point of view along the locus on the entire-celestial-spherical model, is allocated to a specific button of the remote controller 17.

Furthermore, a function of randomly moving the point of view in accordance with points in space previously set to a picture or the like or specific movement information, is allocated to the enter button or arrowed button for left and right of the remote controller 17.

Furthermore, a function of redirecting the point of view to the home position previously set to a picture, is allocated to the home-menu button of the remote controller 17.

Furthermore, a function of zooming a picture in and out (enlargement with the + button and reduction with the − button) is allocated to the channel button of the remote controller 17.

In addition, a function of displaying respective indices or thumbnails of high-resolution partial pictures, is allocated to a specific button of the remote controller 17 (e.g., an index button). Thus, a high-resolution partial picture can be selected with the up-down-left-right button, and the high-resolution partial picture can be displayed with the enter button. Alternatively, any points to which movement can be made are displayed on a picture displayed by the equirectangular projection, and use of a specific button of the remote controller 17 enables selection of a desired point.

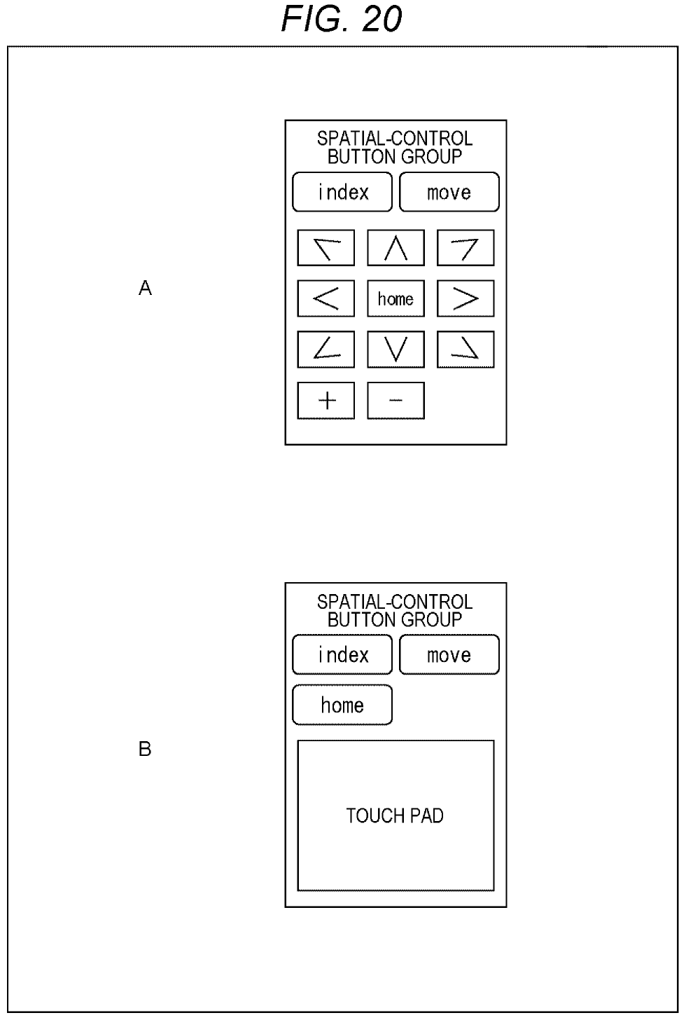

FIG. 20 illustrates exemplary operation units for spatial control that are each installable in the remote controller 17.

As illustrated in A of FIG. 20, an index button, a move button, arrowed buttons for 8 directions, a home button, a plus button, and a minus button can be installed as buttons for spatial control in the remote controller 17.

As illustrated in B of FIG. 20, an index button, a move button, a home button, and a touch pad can be installed as buttons for spatial control in the remote controller 17.

### Exemplary Configuration of Large-Screen Display Device

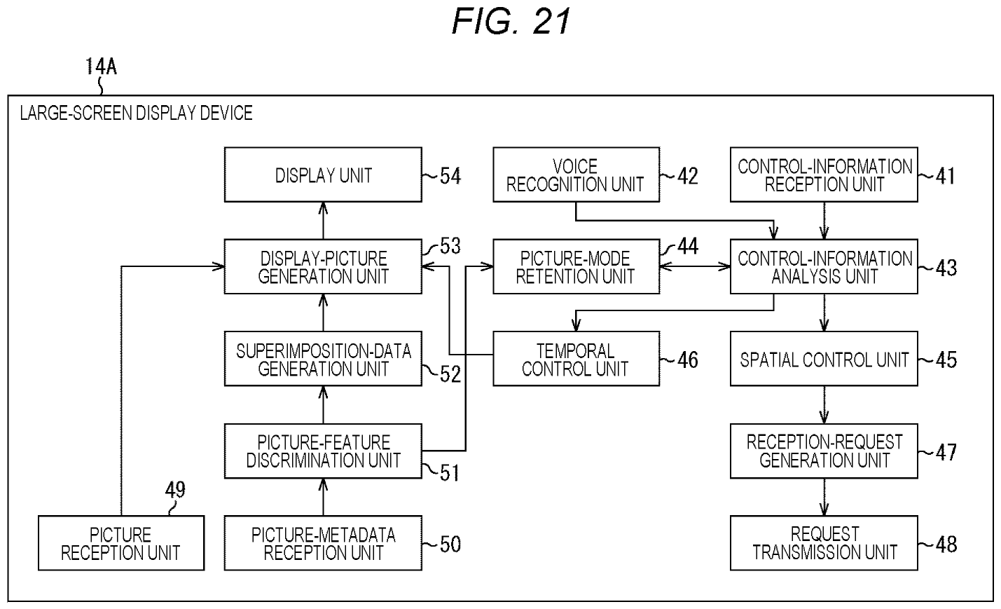

FIG. 21 is a block diagram of an exemplary configuration of the large-screen display device 14A.

As illustrated in FIG. 21, the large-screen display device 14A includes a control-information reception unit 41, a voice recognition unit 42, a control-information analysis unit 43, a picture-mode retention unit 44, a spatial control unit 45, a temporal control unit 46, a reception-request generation unit 47, a request transmission unit 48, a picture reception unit 49, a picture-metadata reception unit 50, a picture-feature discrimination unit 51, a superimposition-data generation unit 52, a display-picture generation unit 53, and a display unit 54.

The control-information reception unit 41 receives control information transmitted from the remote controller 17 in accordance with an operation from the user to the remote controller 17. For example, the control-information reception unit 41 receives control information regarding input of an operation of moving the point of view on a low-resolution entire picture to the remote controller 17 and control of display of a high-resolution partial picture.

For example, the voice recognition unit 42 performs voice recognition processing to a voice converted to an electric signal by a microphone not illustrated, to acquire control information based on the utterance of the user. For example, the voice recognition unit 42 recognizes voice causing input of an operation of moving the point of view on a low-resolution entire picture and control of display of a high-resolution partial picture.

The control-information analysis unit 43 analyzes, for example, the control information received by the control-information reception unit 41 or the control information acquired by the voice recognition processing of the voice recognition unit 42.

The picture-mode retention unit 44 retains whether the picture mode of the large-screen display device 14A is a temporal control mode or a temporal and spatial control mode.

On the basis of the control information analyzed by the control-information analysis unit 43, the spatial control unit 45 controls the space of content that the large-screen display device 14A reproduces.

On the basis of the control information analyzed by the control-information analysis unit 43, the temporal control unit 46 controls the time of content that the large-screen display device 14A reproduces.

The reception-request generation unit 47 generates a viewing/listening request for distribution of a resolution partial picture pursuant to the control of the spatial control unit. 45.

The request transmission unit 48 transmits the viewing/listening request generated by the reception-request generation unit 47 to the distribution server 15 through the network 12.

The picture reception unit 49 receives a low resolution entire picture or a high-resolution partial picture transmitted from the distribution server 15 through the network 12, and then supplies the low-resolution entire picture or the high-resolution partial picture to the display picture generation unit 29.

The picture-metadata reception unit 50 receives picture metadata transmitted from the distribution server 15 through the network 12, and then supplies the picture metadata to the picture-feature discrimination unit 51.

On the basis of the picture metadata received by the picture-metadata reception unit 50, the picture-feature discrimination unit 51 discriminates the picture feature of content to be distributed.

On the basis of the picture metadata received by the picture-metadata reception unit 50, the superimposition-data generation unit 52 generates superimposition data to be superimposed onto the low-resolution entire picture received by the picture reception unit 49.

The display-picture generation unit 53 generates a display picture in which the low-resolution entire picture or the high-resolution partial picture received by the picture reception unit 49 is adapted to the size of view and resolution of the display unit 54, and then the display unit 54 displays the display picture. Furthermore, on the basis of the superimposition data generated by the superimposition-data generation unit 52, the display-picture generation unit 53 generates, for example, a display picture in which high-resolution areas are superimposed on the low-resolution entire picture, a display picture in which respective indices of high-resolution partial pictures are superimposed on the low-resolution entire picture, a display picture in which respective thumbnail images of high-resolution partial pictures are superimposed on the low-resolution entire picture, or the like. Moreover, the display-picture generation unit 53 performs picture reproduction pursuant to the temporal control of the temporal control unit 46 (e.g., fast-forward/fast-reverse/pause/stop), and performs picture reproduction pursuant to the spatial control of the spatial control unit 45 (e.g., movement of the point of view/zooming).

The display unit 54 is, for example, a large-screen display, and displays the display picture generated by the display-picture generation unit 29.

In the large-screen display device 14A having such a configuration, for example, an operation of changing the orientation of the picture being viewed and listened to is performed by a voice specifying a direction (left, right, up, or down) following “more” or “by an angle of oo” or a voice specifying a latitude or longitude on the entire-celestial-spherical model. Furthermore, a voice specifying the index of a high-resolution partial picture may cause display of the high-resolution partial picture corresponding to the index. For example, a voice causes recognition of an index number, the voice “next” in order from the first index causes sequential display of high-resolution partial pictures, or the voice “the o-th” causes display of the high-resolution partial picture of the corresponding index. Furthermore, when an index is specified, the high-resolution partial picture as the display target can be determined by the voice “done”, and the high-resolution partial picture can be displayed by the voice “view and listen to”.

### Seventh Content Distribution Processing

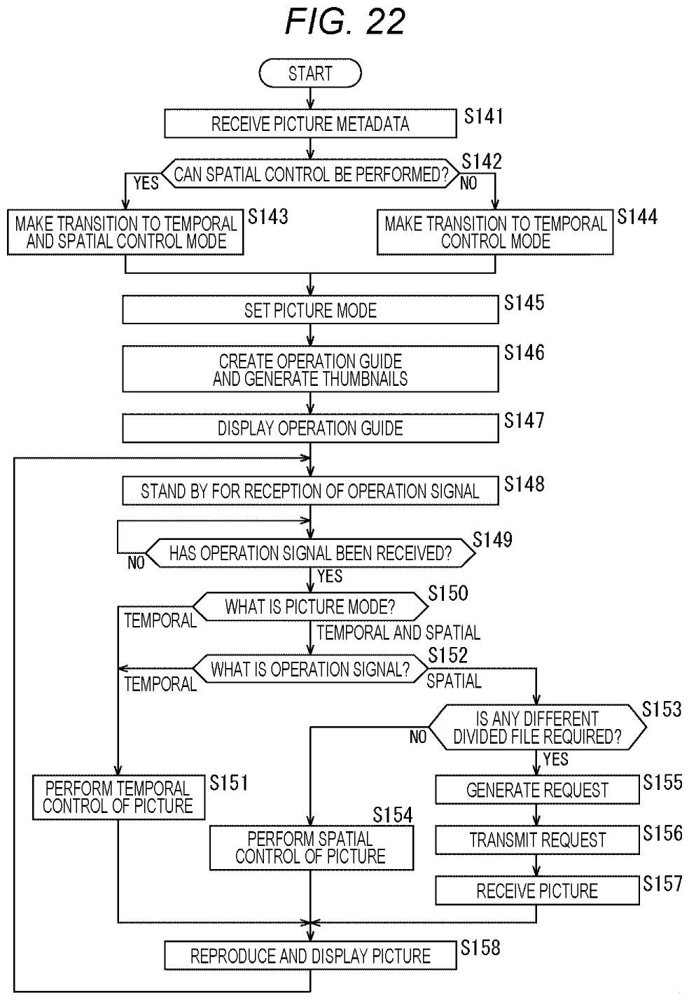

Seventh content distribution processing that is performed in the content distribution system 11A will be exemplarily described with reference to a flowchart illustrated in FIG. 22.

In step S141, the picture-metadata reception unit 50 receives picture metadata transmitted from the distribution server 15.

In step S142, on the basis of the picture metadata. received by the picture-metadata reception unit 50 in step S141, the picture-feature discrimination unit 51 determines whether or not spatial control of content to be distributed can be performed.

In step S142, in a case where the picture-feature discrimination unit 51 determines that spatial control of content to be distributed can be performed, the processing proceeds to step S143, so that the picture mode is determined to transition to the temporal and spatial control mode.

Meanwhile, in step S142, in a case where the picture-feature discrimination unit 51 determines that no spatial control of content to be distributed can be performed, the processing proceeds to step S144, so that the picture mode is determined to transition to the temporal control mode.

After the processing in step S143 or S144, the processing proceeds to step S145, and the picture-feature discrimination unit 51 sets the picture mode retained in the picture-mode retention unit 44. That is, in a case where the picture mode is determined to transition to the temporal and spatial control mode in step S143, the picture mode retained in the picture-mode retention unit 44 is set to the temporal and spatial control mode. Similarly, in a case where the picture mode is determined to transition to the temporal control mode in step S144, the picture mode retained in the picture-mode retention unit 44 is set to the temporal control mode.

In step S146, on the basis of the picture metadata received by the picture-metadata reception unit 50 in step S141, the superimposition-data generation unit 52 creates such an operation guide as illustrated in FIGS. 16 to 18 and generates thumbnails.

In step S147, the display unit 54 displays the operation guide generated by the superimposition-data generation unit 52 in step S146.

In step S148, the control-information reception unit 41 stands by for reception of control information that the remote controller 17 transmits. Note that, in a case where an operation is performed by voice, the voice recognition unit 42 stands by for input of voice.

In step S149, the control-information reception unit 41 determines whether or not the control information transmitted from the remote controller 17 in accordance with an operation from the user to the remote controller 17 has been received. In step S149, in a case where the control-information reception unit 41 determines that no control information has been received, the processing stands by. Meanwhile, in a case where it is determined that the control information has been received, the processing proceeds to step S150.

In step S150, the control-information analysis unit 43 determines whether the picture mode retained in the picture-mode retention unit 44 is the temporal control mode or the temporal and spatial control mode.

In step S150, in a case where the control-information analysis unit 43 determines that the picture mode retained in the picture-mode retention unit 44 is the temporal control mode, the processing proceeds to step S151. In step S151, the temporal control unit 46 performs temporal control of the picture (e.g., fast-forward/fast-reverse/pause/stop).

Meanwhile, in step S150, in a case where the control-information analysis unit 43 determines that the picture mode retained in the picture-mode retention unit 44 is the temporal and spatial control mode, the processing proceeds to step S152.

In step S152, the control-information analysis unit 43 determines whether an operation signal received by the control-information reception unit 41 indicates temporal control or spatial control. In step S152, in a case where the control-information analysis unit 43 determines that the operation signal indicates temporal control, the processing proceeds to step S151, and then processing similar to that described above is performed.

Meanwhile, in step S152, in a case where the control-information analysis unit 43 determines that the operation signal indicates spatial control, the processing proceeds to step S153. In step S153, the spatial control unit 45 determines whether or not any different divided file is required.

In step S153, in a case where the spatial control unit 45 determines that no different divided file is required, the processing proceeds to step S154. In step S154, the spatial control unit 45 performs spatial control of the picture (e.g., movement of the point of view zooming).

Meanwhile, in step S153, in a case where the spatial control unit 45 determines that a different divided file is required, the processing proceeds to step S155. In step S155, the reception-request generation unit 47 generates a viewing/listening request for distribution of the different divided file that the spatial control unit 45 requires.

In step S156, the request transmission unit 48 transmits the viewing/listening request generated by the reception-request generation unit 47 in step S155, to the distribution server 15 through the network 12.

In step S157, the picture reception unit 49 receives a high-resolution partial picture transmitted from the distribution server 15 through the network 12 in response to the viewing/listening request transmitted in step S156.

After the processing in step S151, S154, or S157, the processing proceeds to step S158. Then, the display-picture generation unit 53 reproduces the picture, and the display unit 54 displays the picture. After that, the processing goes back to step S148. After that, similar processing is repeatedly performed.

As above, in the large-screen display device 14A, the user can change the picture in orientation or zoom the picture, for example, without stress by an operation through the remote controller 17 or voice recognition of the voice recognition unit 42, so that the user can easily access a high-resolution partial picture.

Then, in each of the content distribution systems 11 and 11A, for high-resolution partial pictures prepared by hierarchically division technology, the corresponding locations on an entire-celestial-spherical low-resolution entire picture and the respective features of the high-resolution pictures are displayed, so that the user can grasp the presence of viewable and audible high-resolution pictures and can view and listen to the high-resolution. pictures.

### Exemplary Configuration of Computer

Next, each flow of processing described above (display control method) can be performed by hardware or software. In a case where each flow of processing is performed by software, a program included in the software is installed on, for example, a general-purpose computer.

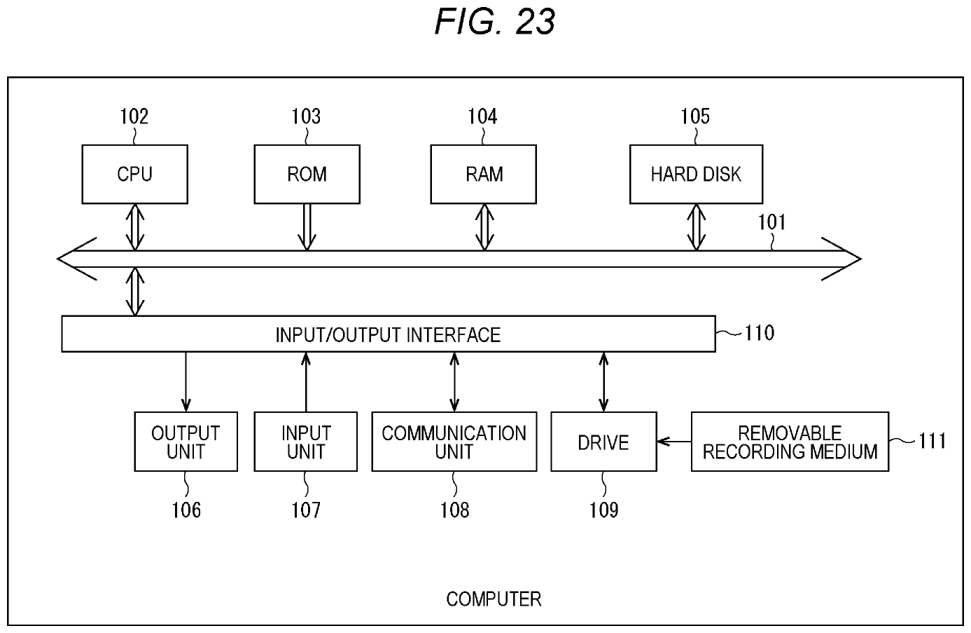

FIG. 23 is a block diagram of an exemplary configuration of a computer according to an embodiment on which a program for performing any of the flows of processing described above is installed.

The program can be previously recorded on a hard disk 105 or a ROM 103 as a recording medium built in the computer.

Alternatively, the program can be stored (recorded) in a removable recording medium 111 that a drive 109 drives. The removable recording medium 111 can be provided as so-called packaged software. Here, examples of the removable recording medium 111 include a flexible disk, a compact disc read only memory (CD-ROM), a magneto optical (MO) disc, a digital versatile disc (DVD), a magnetic disk, a semiconductor memory, and the like.

Note that the program not only can be installed from the removable recording medium 111 described above onto the computer, but also can be installed on the built-in hard disk 105 by download to the computer through a communication network or a broadcast network. That is, for example, the program can be transferred from a download site to the computer by wireless through an artificial satellite for digital satellite broadcasting or by wire through a network, such as a local area network (LAN) or the Internet.

The computer includes a central processing unit (CPU) 102 built therein, and the CPU 102 is connected with an input/output interface 110 through a bus 101.

For example, when a user operates an input unit 107 to input a command through the input/output interface 110, in accordance with the command, the CPU 102 executes the program stored in the read only memory (ROM) 103. Alternatively, the CPU 102 loads the program stored in the hard disk 105 into a random access memory (RAM) 104 and executes the program.

This arrangement causes the CPU 102 to perform the processing corresponding to any of the flowcharts described above or the processing in the configuration in any of the block diagrams described above. Then, for example, as necessary, through the input/output interface 110, the CPU 102 causes an output unit 106 to output a result of the processing or a communication unit 108 to transmit the result of the processing, and moreover records the result of the processing on the hard disk 105.

Note that the input unit 107 includes, for example, a keyboard, a mouse, and a microphone. Furthermore, the output unit 106 includes, for example, a liquid crystal display (LCD) and a speaker.

Here, in the present specification, the processing that the computer performs in accordance with the program, is not necessarily performed on a time-series basis in the order described in the corresponding flowchart. That is the processing that the computer performs in accordance with the program includes processing to be performed parallel or individually (e.g., parallel processing or processing with object).

Furthermore, the program may be subjected to processing by one computer (processor) or may be subjected to decentralized processing by a plurality of computers. Moreover, the program may be transferred to a remote computer so as to be executed.

Moreover, in the present specification, the system means an aggregate of a plurality of constituent elements (e.g., devices and modules (components)) regardless of whether or not all the constituent elements are included in the same housing. Therefore, a plurality of devices connected through a network, the devices each being housed in a different housing, and one device including a plurality of modules housed in one housing, are involved all in the system.

Furthermore, for example, a configuration described as one device (or one processing unit) may be divided to form a plurality of devices (or processing units). Conversely, configurations described above as a plurality. of devices (or processing units) may be integrated to form one device (or one processing unit). Furthermore, the configuration of each device (or each processing unit) may be given a configuration other than the configurations described above. Moreover, as long as the configuration or operation of the entire system remains substantially the same, the configuration of a device (or a processing unit) may be partially included in the configuration of a different device (or a different processing unit).

Furthermore, for example, the present technology can have the configuration of cloud computing in which a plurality of devices dividedly processes one function in cooperation through a network.

Furthermore, for example, the program described above can be executed by an arbitrary device. In that case, the device is only required to have necessary functions (e.g., functional blocks) and to be capable of acquiring necessary information.

Furthermore, for example, each step in each flowchart described above can be performed by one device or can be dividedly performed by a plurality of devices. Moreover, in a case where one step includes a plurality of pieces of processing, the plurality of pieces of processing included in the one step can be performed by one device or can be dividedly performed by plurality of devices. In other words, a plurality of pieces of processing included in one step can be performed as the processing in a plurality of steps. Conversely, processing described as a plurality of steps can be collectively performed as one step.

Note that, regarding the program that the computer executes, the processing in the steps describing the program may be performed on a time-series basis in the order described in the present specification or may be performed in parallel or individually with necessary timing, such as a call. That is, as long as no inconsistency occurs, the processing in each step may be performed in order different from the order described above. Moreover, the processing in the steps describing the program may be performed in parallel with the processing of a different program or may be performed in combination with the processing of a different program.

Note that each of the plurality of configurations according to the present technology described in the present specification can be achieved independently and individually as long as no inconsistency occurs. Needless to say, any plurality of configurations according to the present technology can be achieved together. For example, the entirety or part of any of the embodiments according to the present technology can be achieved in combination with the entirety or part of another embodiment according to the present technology. Furthermore, any part or all according to the present technology described above can be achieved together with another technology not described above.

### Exemplary Combinations of Configurations

Note that the present technology can have the following configurations.

(1)

A display control device including:

a superimposition-data generation unit configured to generate, in reproduction of content hierarchically including a plurality of high-definition partial pictures and a low-resolution entire picture including the plurality of partial pictures as regions, superimposition data to be superimposed onto the entire picture, on the basis of metadata regarding the partial pictures;

a display-picture generation unit configured to generate a display picture in which a picture based on the superimposition data is superimposed on the entire picture; and

a request transmission unit configured to transmit a request for distribution of a desired partial picture selected from the partial pictures with the display picture.

(2)

The display control device according to (1) above, in which

the superimposition-data generation unit generates, as the superimposition data, a high-resolution area such that areas in which the partial pictures are present are enclosed on the entire picture.

(3)

The display control device according to (1) above, in which

the superimposition-data generation unit generates, as the superimposition data, indices of the partial pictures.

(4)

The display control device according to (3) above, in which

the metadata includes IDs that are linked with the indices and rank the partial pictures.

(5)

The display control device according to (1) above, in which the superimposition-data generation unit generates, as the superimposition data, thumbnail images of the partial pictures.

(6)

The display control device according to (5) above, in which

the thumbnail images are generated either in a reproduction device that reproduces the content or in a distribution device that distributes the content.

(7)

The display control device according to (1) above, in which

a thumbnail-superimposed picture in which thumbnail images of the partial pictures are superimposed on the entire picture is generated so as to be distributed in a distribution device that distributes the content, and

the request transmission unit transmit, in accordance with a location specified on the thumbnail superimposed picture, the request for the partial picture arranged at the location.

(8)

The display control device according to (1) above, in which

in a case where the desired partial picture is specified for viewing and listening in a display of the entire picture and the desired partial picture is not present in a reproduction device that reproduces the content, the request transmission unit transmits the request for generation of the desired partial picture for distribution in the reproduction device that reproduces the content.

(9)

The display control device according to any of (1) to (8) above, in which

a first display device that displays the display picture generated by the display-picture generation unit and controls the selection of the desired partial picture as a display target, is different from a second display device that displays the desired partial picture transmitted in response to the request.

(10)

The display control device according to any of (1) to (9) above, further including:

a control unit configured to control display in accordance with control information from a control device including a plurality of buttons for input of an operation or moving a point of view on the entire picture and control of display of the desired partial picture.

(11)

The display control device according to any of (1) to (10) above, further including:

a voice recognition unit configured to recognize voice causing input of an operation of moving a point of view on the entire picture and control of display of the desired partial picture, in which

the control unite, controls display in accordance with a recognition result from the voice recognition unit.

(12)

A display control method including:

generating, in reproduction of content hierarchically including a plurality of high-definition partial pictures and a low-resolution entire picture including the plurality of partial pictures as regions, superimposition data to be superimposed onto the entire picture, on the basis of metadata regarding the partial pictures;

generating a display picture in which a picture based on the superimposition data is superimposed on the entire picture; and

transmitting a request for distribution of a desired partial picture selected from the partial pictures with the display picture.

(13)

A program for causing a computer of a display control device that performs display control, to perform. processing including:

generating, in reproduction of content hierarchically including a plurality of high-definition partial pictures and a low-resolution entire picture including the plurality of partial pictures as regions, superimposition data to be superimposed onto the entire picture, on the basis of metadata regarding the partial pictures;

generating a display picture in which a picture based on the superimposition data is superimposed on the entire picture; and

transmitting a request for distribution of a desired partial picture selected from the partial pictures with the display picture.

Note that the present embodiment is not limited to the embodiments described above, and thus various alterations may be made without departing from the scope of the gist of the present disclosure. Furthermore, the effects described in the present specification are just exemplary and are not limitative, and thus other effects may be provided.

### REFERENCE SIGNS LIST

11 Content distribution system

12 Network

13 Mobile display device

14 Large-screen display device

15 Distribution server

16 Content storage unit

17 Remote controller

21 User-operation detection unit

22 Control-information acquisition unit

23 Control-information analysis unit

24 Reception-request generation unit

25 Request transmission unit

26 Picture reception unit

27 Picture-metadata reception unit

28 Superimposition-data generation unit

29 Display-picture generation unit

30 Display unit

41 Control-information reception unit

42 Voice recognition unit

43 Control-information analysis unit

44 Picture-mode retention unit

45 Spatial control unit

46 Temporal control unit

47 Reception-request generation unit

48 Request transmission unit

49 Picture reception unit

50 Picture-metadata reception unit

51 Picture-feature discrimination unit

52 Superimposing-data generation unit

53 Display-picture generation unit

54 Display unit

1. A display control device comprising:
a superimposition-data generation unit configured to generate, in reproduction of content hierarchically including a plurality of high-definition partial pictures and a low-resolution entire picture including the plurality of partial pictures as regions, superimposition data to be superimposed onto the entire picture, on a basis of metadata regarding the partial pictures;
a display-picture generation unit configured to generate a display picture in which a picture based on the superimposition data is superimposed on the entire picture; and
a request transmission unit configured to transmit a request for distribution of a desired partial picture selected from the partial pictures with the display picture.

2. The display control device according to claim 1, wherein
the superimposition-data generation unit generates, as the superimposition data, a high-resolution area such that areas in which the partial pictures are present are enclosed on the entire picture.

3. The display control device according to claim 1, wherein
the superimposition-data generation unit generates, as the superimposition data, indices of the partial pictures.

4. The display control device according to claim 3, wherein
the metadata includes IDs that are linked with the indices and rank the partial pictures.

5. The display control device according to claim 1, wherein
the superimposition-data generation unit generates, as the superimposition data, thumbnail images of the partial pictures.

6. The display control device according to claim 5, wherein
the thumbnail images are generated either in a reproduction device that reproduces the content or in a distribution device that distributes the content.

7. The display control device according to claim 1, wherein
a thumbnail-superimposed picture in which thumbnail images of the partial pictures are superimposed on the entire picture is generated so as to be distributed is a distribution device that distributes the content, and
the request transmission unit transmit, in accordance with a location specified on the thumbnail-superimposed picture, the request for the partial picture arranged at the location.

8. The display control device according to claim 1, wherein
in a case where the desired partial picture is specified for viewing and listening in a display of the entire picture and the desired partial picture is not present in a reproduction device that reproduces the content, the request transmission unit transmits the request for generation of the desired partial picture for distribution in the reproduction device that reproduces the content.

9. The display control device according to claim 1, wherein
a first display device that displays the display picture generated by the display-picture generation unit and controls the selection of the desired partial picture as a display target, is different from a second display device that displays the desired partial picture transmitted in response to the request.

10. The display, control device according to claim 1, further comprising:
a control unit configured to control display in accordance with control information from a control device including a plurality of buttons for input of an operation of moving a point of view on the entire picture and control of display of the desired partial picture.

11. The display control device according to claim 10, further comprising:
a voice recognition unit configured to recognize voice causing input of an operation of moving a point of view on the entire picture and control of display of the desired partial picture, wherein
the control unit controls display in accordance with a recognition result from the voice recognition unit.

12. A display control method comprising:
generating, in reproduction of content hierarchically including a plurality of high-definition partial pictures and a low-resolution entire picture including the plurality of partial pictures as regions, superimposition data to be superimposed onto the entire picture, on a basis of metadata regarding the partial pictures;
generating a display picture is which a picture based on the superimposition data is superimposed on the entire picture; and
transmitting a request for distribution of a desired partial picture selected from the partial pictures with the display picture.

13. A program for causing a computer of a display control device that performs display control, to perform processing comprising:
generating, in reproduction of content hierarchically including a plurality of high-definition partial pictures and a low-resolution entire picture including the plurality of partial pictures as regions, superimposition data to be superimposed onto the entire picture, on. a basis of metadata regarding the partial pictures;
generating a display picture in which a picture based on the superimposition data is superimposed on the entire picture; and
transmitting a request for distribution of a desired partial picture selected from the partial pictures with the display picture.
